(19) United States
(12) Patent Application Publication
(10) Pub. No.: US 2024/0118892 A1
(43) Pub. Date: Apr. 11, 2024

(54) APPARATUSES, METHODS, AND SYSTEMS FOR NEURAL NETWORKS

(71) Applicant: Intel Corporation, Santa Clara, CA (US)

(72) Inventors: Swagath VENKATARAMANI, Tirupur (IN); Dipankar DAS, Pune (IN); Ashish RANJAN, West Lafayette, IN (US); Subarno BANERJEE, Kolkata (IN); Sasikanth AVANCHA, Malur Taluk (IN); Ashok JAGANNATHAN, Bangalore (IN); Ajaya V. DURG, Austin, TX (US); Dheemanth NAGARAJ, Bangalore (IN); Bharat KAUL, Bengaluru (IN); Anand RAGHUNATHAN, West Lafayette, IN (US)

(21) Appl. No.: 18/543,357

(22) Filed: Dec. 18, 2023

Related U.S. Application Data
(63) Continuation of application No. 17/511,417, filed on Oct. 26, 2021.
Application No. 17/511,417 is a continuation of application No. 16/317,497, filed on Jan. 11, 2019, now abandoned.

(30) Foreign Application Priority Data
Aug. 13, 2016 (IN) 201641027751

(51) Int. Cl. G06F 9/30; G06F 9/38; G06F 9/52; G06N 3/04; G06N 3/063; G06N 3/084

(52) U.S. Cl. CPC G06F 9/30145; G06F 9/3004; G06F 9/30043; G06F 9/30087; G06F 9/3834; G06F 9/52; G06N 3/04; G06N 3/063; G06N 3/084

(57) ABSTRACT

Methods and apparatuses relating to processing neural networks are described. In one embodiment, an apparatus to process a neural network includes a plurality of fully connected layer chips coupled by an interconnect; a plurality of convolutional layer chips each coupled by an interconnect to a respective fully connected layer chip of the plurality of fully connected layer chips and each of the plurality of fully connected layer chips and the plurality of convolutional layer chips including an interconnect to couple each of a forward propagation compute intensive tile, a back propagation compute intensive tile, and a weight gradient compute intensive tile of a column of compute intensive tiles between a first memory intensive tile and a second memory intensive tile.

### CROSS-REFERENCE TO RELATED APPLICATIONS

This application is a continuation application of U.S. patent application Ser. No. 17/511,417 filed Oct. 26, 2021, which is a continuation application of U.S. patent application Ser. No. 16/317,497 filed Jan. 11, 2019, which is a national stage application of International Application No. PCT/US2016/053980 filed Sep. 27, 2016, which claims the benefit of Indian Provisional Patent Application No. 201641027751 filed Aug. 13, 2016 and entitled “Scalable Processor Architecture for Neural Networks,” each of which is incorporated herein by reference.

### TECHNICAL FIELD

The disclosure relates generally to electronics, and, more specifically, an embodiment of the disclosure relates to a processor to process a neural network.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a network level data flow in training a neural network according to embodiments of the disclosure.

FIG. 2 illustrates a layer level data flow for a convolutional (CONV) layer in training a neural network according to embodiments of the disclosure.

FIG. 3 illustrates a layer level data flow for a sampling (SAMP) layer in training a neural network according to embodiments of the disclosure.

FIG. 4 illustrates a layer level data flow for a fully connected (FC) layer in training a neural network according to embodiments of the disclosure.

FIG. 5 illustrates the computational and data characteristics of a sample neural network according to embodiments of the disclosure.

FIG. 6 illustrates the summary of operations for training a sample neural network according to embodiments of the disclosure.

FIG. 7 illustrates a compute intensive tile according to embodiments of the disclosure.

FIG. 8 illustrates a memory intensive tile according to embodiments of the disclosure.

FIG. 9 illustrates a chip with compute intensive tiles and memory intensive tiles according to embodiments of the disclosure.

FIGS. 10A-B illustrate instructions according to embodiments of the disclosure.

FIG. 11 illustrates the computations realized on a chip with compute intensive tiles and memory intensive tiles for the forward propagation of a convolutional layer according to embodiments of the disclosure.

FIG. 12 illustrates the two level nested pipelining of a chip according to embodiments of the disclosure.

FIG. 13 illustrates a convolutional layer chip according to embodiments of the disclosure.

FIG. 14 illustrates a fully connected layer chip according to embodiments of the disclosure.

FIG. 15 illustrates an example of a computing system with a node architecture to couple a plurality of fully connected layer chips and convolutional layer chips according to embodiments of the disclosure.

FIG. 16 illustrates the mapping of a neural network to a computing system according to embodiments of the disclosure.

FIG. 17 illustrates an example mapping of a neural network to a computing system according to embodiments of the disclosure.

FIGS. 18A-B illustrate the mapping of a neural network to a computing system to compile code according to embodiments of the disclosure.

FIG. 19 illustrates the architectural parameters of a computing system according to embodiments of the disclosure.

FIG. 20 illustrates example training and evaluation performance and compute utilization of a computing system according to embodiments of the disclosure.

FIG. 21 illustrates a flow diagram to evaluate each feature of a layer according to embodiments of this disclosure.

FIG. 22 illustrates a flow diagram according to embodiments of the disclosure.

FIG. 23A is a block diagram illustrating both an exemplary in-order pipeline and an exemplary register renaming, out-of-order issue/execution pipeline according to embodiments of the disclosure.

FIG. 23B is a block diagram illustrating both an exemplary embodiment of an in-order architecture core and an exemplary register renaming, out-of-order issue/execution architecture core to be included in a processor according to embodiments of the disclosure.

FIG. 24A is a block diagram of a single processor core, along with its connection to the on-die interconnect network and with its local subset of the Level 2 (L2) cache, according to embodiments of the disclosure.

FIG. 24B is an expanded view of part of the processor core in FIG. 24A according to embodiments of the disclosure.

FIG. 25 is a block diagram of a processor that may have more than one core, may have an integrated memory controller, and may have integrated graphics according to embodiments of the disclosure.

FIG. 26 is a block diagram of a system in accordance with one embodiment of the present disclosure.

FIG. 27 is a block diagram of a more specific exemplary system in accordance with an embodiment of the present disclosure.

FIG. 28 is a block diagram of a second more specific exemplary system in accordance with an embodiment of the present disclosure.

FIG. 29 is a block diagram of a system on a chip (SoC) in accordance with an embodiment of the present disclosure.

FIG. 30 is a block diagram contrasting the use of a software instruction converter to convert binary instructions in a source instruction set to binary instructions in a target instruction set according to embodiments of the disclosure.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A (e.g., hardware) processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decode unit (decoder) decoding macro-instructions. A processor (e.g., having one or more cores to decode and/or execute instructions) may operate on data, for example, in performing arithmetic, logic, or other functions. A processor (e.g., processing system) may process a neural network. In certain embodiments, a (e.g., artificial) neural network generally refers to a group of artificial neurons (e.g., algorithms) that are used to estimate or approximate functions that depend on a large number of inputs that are generally unknown.

Deep Neural Networks (DNNs), a class of machine learning algorithms inspired by the human brain, demonstrate state-of-the-art performance on a variety of recognition tasks and may be ubiquitously employed in many real world applications. However, DNNs may impose significant computational challenges owing to the complexity of the networks and the amount of data they process, both of which may grow in future. To improve the efficiency of both training and evaluating neural networks (e.g., DNNs), certain embodiments herein provide for a dense, scalable compute node architecture, whose compute, memory, and/or interconnect subsystems are specialized to leverage the compute and communication characteristics of DNNs. In certain embodiments herein, the architectural features increase the processing efficiency. Certain embodiments herein include: (i) heterogeneous processing tiles and chips that meet the varying needs of the operations constituting a neural network (e.g., DNN), (ii) a 3-tiered chip/node-level interconnect topology that matches the data-flow present in neural networks (e.g., DNNs), (iii) methods to map neural networks (e.g., DNNs) to a processor (e.g., processing system) that localizes computations to minimize data movement and improves core utilization through nested pipelining, and/or (iv) a low overhead synchronization mechanism based on hardware dataflow trackers. In one embodiment herein, a processor (e.g., processing system) to process a neural network may deliver 680 TFLOPs peak at 1.4 KW of power consumption, e.g., to achieve 6 to 28 times improvement in performance on a DNN topologies containing 0.65-14.9 million neurons and 6.8-145.9 million weights, for example, a processor with 7032 cores operating at 600 MHz.

A processor (e.g., processing system) to process a neural network may be a computing system made up of a number of (e.g., highly) interconnected processing elements, which process information by their dynamic state response to external inputs. With an increase in the amount of digital data and the proliferation of connected devices, DNNs may receive significant interest, and represent the state-of-the-art on a variety of video, image, audio, and text recognition problems. DNNs may be widely deployed in many real-world applications, for example, an internet image search, voice activated software (e.g., search or language translation), among many more, for example, in the fields of autonomous vehicles, biomedicine, virtual reality etc. While neural networks (e.g., DNNs) enable significant applications, training and/or evaluating neural networks (e.g., DNNs) may be highly compute and data intensive. Two example scenario of an extreme computational challenge imposed by neural networks (e.g., DNNs) are: (i) an embedded inference, in which neural networks (e.g., DNNs) are deployed and evaluated on energy-constrained devices (such as Internet-of-Things (IoT) edge devices) and (ii) cloud-based training, in which neural networks (e.g., DNNs) are trained on the cloud under stringent performance constraints.

Certain neural networks utilize one or a plurality of giga-floating point operations per second (GFLOPs) or petaFLOPs (PFLOPs), e.g., for evaluating a single input. For example, a neural network for image recognition may contain about 820K neurons and about 145M parameters, and utilize around 3.3 giga-floating point operations per second (GFLOPs) for evaluating a single 230×230 input image. Similarly, training for one epoch (e.g., the presentation of the entire training set to the neural network) on a dataset with 1.2 million images may consume about 15 petaFLOPs (PFLOPs) of processing resources. Certain embodiments of learning algorithms, such as Stochastic Gradient Descent (SGD), may take 50-100 epochs to converge, e.g., making neural network training an exascale problem. The processing resources for training and evaluating neural networks (e.g., DNNs) may rapidly increase (e.g., greater than 10×), as larger datasets and networks of higher complexity (e.g., more layers, more features, larger feature sizes, etc.) are actively explored and developed.

Certain embodiments herein include a compiler front-end to program a (e.g., any) neural network (e.g., DNN) topology to a processor (e.g., a processing system), and/or a detailed cycle-accurate architectural simulator to estimate performance and energy. The simulator may also incorporate power models based on gate-level synthesis to a processor's (e.g., 14 nm) technology node. Although certain embodiments herein refer to use with a Deep Neural Network (DNN), other neural networks may be utilized.

The following sections discuss embodiments of computational characteristics of neural networks (e.g., DNNs) in Section I, embodiments of computing architecture in Section II, embodiments of a compiler front-end for programming in Section III, examples of an evaluation methodology in Section IV, and example results of the evaluation methodology in Section V.

### I. Computational Characteristics

The below section describes example algorithms to train and evaluate Deep Neural Networks (DNNs), and identify the (e.g., key) computation patterns involved in their realization. This section then presents a detailed analysis of an example DNN workload and uses it to quantify the computational challenges in implementing those DNNs and highlight the opportunities to improve their efficiency.

### A. Preliminaries

In certain embodiments, the fundamental compute primitive of a neural network (e.g., DNN) is an artificial neuron. Each neuron may be associated with a set of parameters called weights. In one embodiment, the neuron is a multiple-input and one-output function, e.g., which evaluates weighted sum of its inputs followed by an (e.g., non-linear) activation function to produce the output. DNNs may be comprised of several (e.g., millions of) neurons connected to each other. While any variant of neural networks (e.g., DNNs) may be utilized, the below is generally related to feedforward networks in which the network is organized in layers, e.g., with neurons in a given layer connected only to neurons in the successive layer. In one embodiment, DNNs are operated in two phases: (i) Training/Learning and (ii) Testing/Evaluation. In the training phase, a training dataset labeled with (e.g., golden) class outputs may be used to learn the network parameters. In the testing phase, the trained network may be deployed and used to classify a given input into one of the output classes. Additionally or alternatively to improving the evaluation phase, certain embodiments of a processor (e.g., processing system) architecture improve the efficiency of both the training and testing phases. The training process may encompass the steps carried out during network evaluation, and therefore describe DNN training in more detail.

### B. Neural Network Training: Data Flow

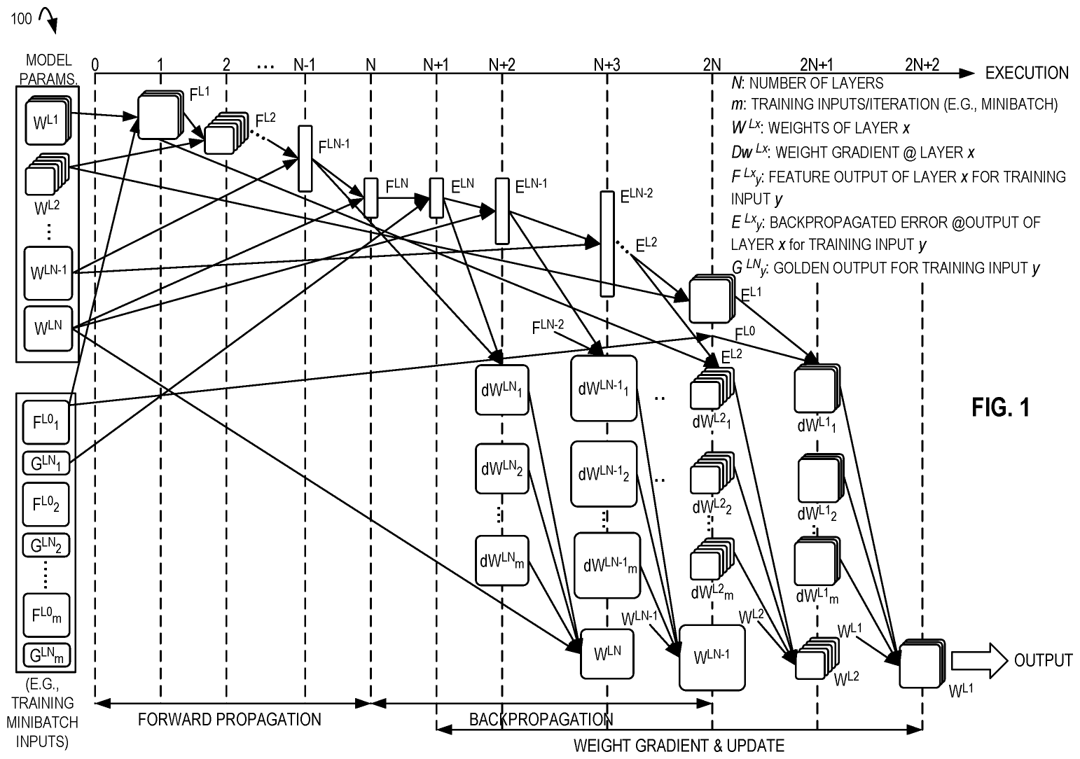

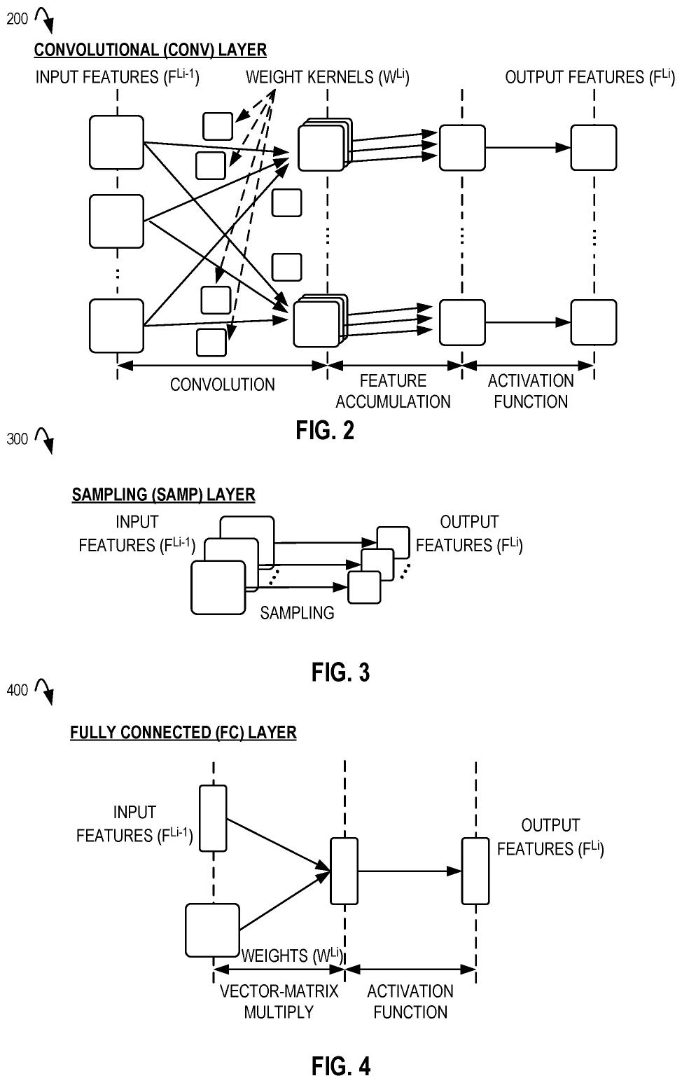

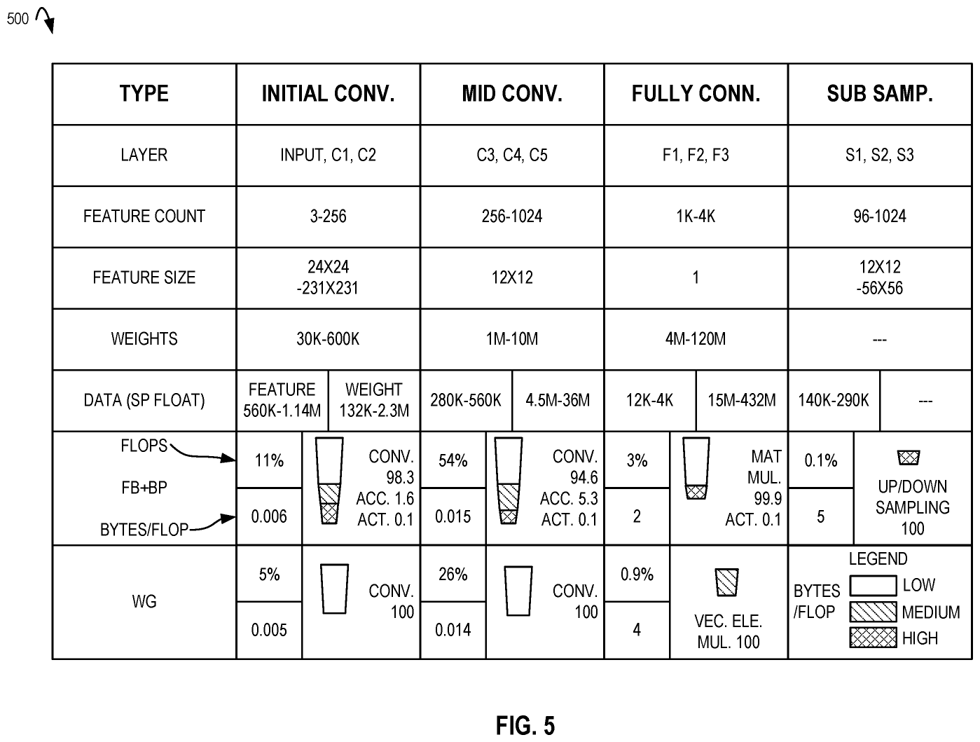

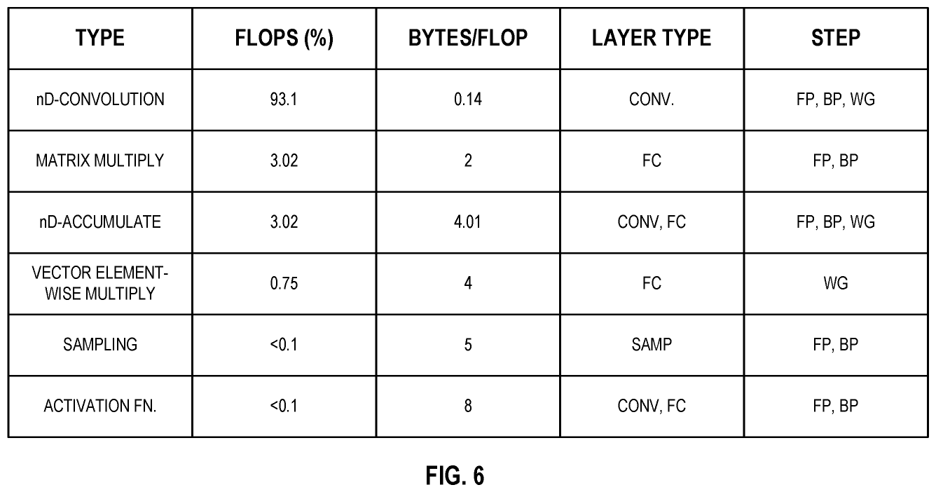

Turning to the Figures, FIG. 1 illustrates a network level data flow 100 in training a neural network according to embodiments of the disclosure. FIG. 2 illustrates a layer level data flow 200 for a convolutional (CONV) layer in training a neural network according to embodiments of the disclosure. FIG. 3 illustrates a layer level data flow 300 for a sampling (SAMP) layer in training a neural network according to embodiments of the disclosure. FIG. 4 illustrates a layer level data flow 400 for a fully connected (FC) layer in training a neural network according to embodiments of the disclosure. FIGS. 1-4 hierarchically illustrates the computations during an example DNN training. For example, given a set of training inputs (F^{L0}) and respective golden output vectors (G^{LN}), the training process learns the weights (W) (e.g., weight kernels) associated with each neuron in the network. In certain embodiments, the training process utilizes the Stochastic Gradient Descent (SGD) algorithm, which is iterative, e.g., the weights are randomly initialized and in each iteration a training example is used to update the weights of the network such that the difference between the network output and the golden output is minimized.

The network-level data flow in each iteration of this DNN training is shown in FIG. 1. The depicted embodiment involves the following 3 steps:
Forward Propagation (FP): Neurons in each layer are evaluated in succession until the network outputs are reached. Computations corresponding to each layer may start (e.g., only) after the previous layer is complete, whereas neurons within each layer may be evaluated in parallel.
Backpropagation (BP): The difference between the golden and network outputs is evaluated. The error at the output is propagated back through the network. The computations are similar to FP, e.g., error at an input of a layer is computed as the weighted sum of the errors at the output of each neuron fed by the input. Errors may be backpropagated through all neurons in a layer in parallel, while BP for a layer may commence (e.g., only) after BP through its successive layer is complete.
Weight Gradient and Update (WG): The amount by which each weight in the network is modulated is generally referred to as the weight gradient. It may be computed by accumulating the product of the FP outputs and BP errors corresponding to a given weight. Thus gradients corresponding to each weight in a layer may be computed in parallel, e.g., as soon as the error at the output of the layer is available. In certain embodiments, training iterations are repeated several times over the entire training dataset (e.g., referred to as epochs) until the weights converge. In one embodiment, multiple training inputs are grouped into a minibatch. The FP, BP, and WG steps corresponding to each input in a minibatch may be computed in parallel. After this, their gradients may be accumulated together to update the network weights. Algorithmically, as gradients are averaged, minibatching may smoothen convergence, e.g., while yielding significant parallelism from a compute perspective. In one embodiment, DNN evaluation involves (e.g., only) the FP step, and the test inputs are labelled the class corresponding to the neuron with the largest value at the network outputs. The computations performed during the FP, BP and WG steps may vary based on the layer type, e.g., which broadly defines how neurons of a layer are connected to the layer inputs. In certain embodiments, there are three types of layers, and FIGS. 2-4 illustrates the layer-level data flow for each layer type, respectively.

Convolutional (CONV) Layer: The neurons in a convolutional layer may be arranged as multiple dimensional grids (e.g., two, three, four dimensional, etc.) called features. In one embodiment, the layer takes multiple input features and produces multiple feature outputs. In the case of FP, each output feature may be computed by: (i) convolving each input feature with a weight matrix called a kernel, (ii) accumulating the convolved output features, and (iii) performing an (e.g., non-linear) activation function on the accumulated sum. This process may be repeated for all output features. In some cases, a connection table denoting which input and output features are connected is specified. The BP/WG steps may be formulated similarly as convolutions followed by accumulations.

Sampling (SAMP) Layer: These layers may take multiple input features and produce a (e.g., equal) plurality of output features. In FP, output features may be produced by down-sampling (e.g., max-pooling or averaging) the input features, e.g., reducing feature size. Similarly, errors may be up-sampled during BP. In certain embodiment, these layers do not contain weights and hence no WG is performed.

Fully-Connected (FC) Layer: Neurons of a fully connected layer may be organized as a vector. In certain embodiments, each neuron is connected to all layer inputs through a distinct weight. The FP/BP steps may be formulated as a vector-matrix multiplication followed by activation function. The WG step may be an element-wise product of the FP output and BP error vectors. A deep network may include a series of convolution layers (e.g., 5-30 CONV layers) followed by (e.g., fewer) fully connected layers (e.g., 1-3 FC layers). Sampling layers may follow some convolutional layers. The convolutional layers may extract local features by moving the kernel across the input features. As processing progress through the neural network (e.g., DNN), local features may be composed to construct global features, e.g., which are then used by the fully connected layers to classify the input.

### C. Workload Analysis

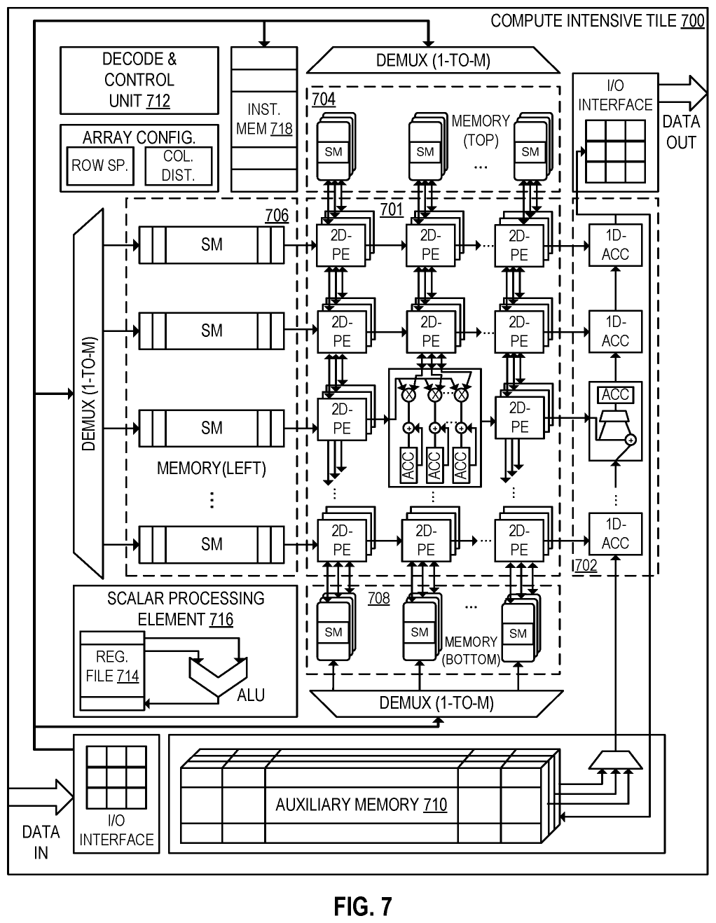

FIG. 5 illustrates the computational and data characteristics 500 of a sample neural network according to embodiments of the disclosure, e.g., by using an image recognition DNN as a representative example. This example DNN includes 11 layers: with 5 convolutional layers (C1-C5), 3 sampling layers (S1-S3), and 3 fully connected layers (F1-F3). Significant heterogeneity in computations within a layer and across layers may be observed here.

Inter-layer Heterogeneity: To demonstrate the heterogeneity across layers, FIG. 5 lists the compute and data requirements for each layer type in this example neural network. The convolutional layers may be split into two classes, for example, initial convolutional (C1, C2) and mid convolutional (C3-C5) layers. Among the convolutional layers, the initial convolutional layers in this sample neural network have a relatively small number of features (e.g., about 4×-11×), each of which are larger (e.g., about 4×-16×) in size. On the contrary, the mid convolutional layers operate on a large number of smaller sized features in this example neural network. In certain embodiments, feature count determines the number of convolutions and consequently the number of weights, e.g., in this example neural network, the mid convolutional layers have (e.g., about 16×-30×) more weights compared to the initial convolutional layers. However, note that each convolution in this example neural network is “A” times bulkier in the initial convolutional layers, e.g., owing to its large feature size. The fully connected layers in this example neural network are the smallest in terms of number of neurons (e.g., 1000s), but contains (e.g., about 10×) more weights, e.g., as each connection carries a distinct weight. In the case of SAMP layers in this example neural network, the feature count equals the convolutional layers it follows, the feature sizes are smaller in proportion to the sampling window dimensions, and do not have any weights. The heterogeneity in terms of layer topologies in this example neural network translates into differing compute and data requirements.

FIG. 5 tabulates the FLOPs count and Bytes/FLOP utilized (e.g., required) by the different layers in the case of FP, BP and WG in this example neural network. In certain embodiments, single precision floating point representation is used for both features and weights. The initial convolutional layers in this example neural network contribute about 16% of the overall FLOPs, while the mid convolutional layers contribute about 80%. The fully connected layers in this example neural network are quite small, about 4% of OPS, while SAMP layers contribute only a negligible amount (about 0.1%). In terms of Bytes/FLOP, the initial convolutional layers in this example neural network offer the most opportunity for weight reuse, e.g., as the feature sizes (e.g., convolutions) are significantly larger. The input features in this example neural network are most reused in the mid convolutional layers, e.g., as their feature count is large. Due to these factors, the convolutional layers in this example neural network are the lowest in terms of Bytes/FLOP, 0.006 and 0.015 for the initial and mid convolutional layers, respectively. The weights in fully connected layers in this example neural network may offer no reuse and their feature sizes may be quite small, e.g., resulting in a substantially higher Bytes/FLOP of 2. Each feature in SAMP layers in this example neural network may be used only once, e.g., and therefore they exhibit the highest Bytes/FLOP ratio of 5. In summary, the convolutional layers in this example neural network account for a significant fraction of the FLOPs while offering significant opportunities for data reuse. On the other hand, the fully connected layers in this example neural network demand high Bytes/FLOP, but contribute only a small fraction to the total FLOPs. Further, as processing progress through this example neural network, from the initial and mid convolutional layers to the fully connected layers, there may be an increasing feature count, decreasing feature sizes, and a substantial growth in weights.

Intra-layer Heterogeneity: In this example neural network, computations that constitute a layer also exhibit differing computational characteristics. In the initial convolutional layers in this example neural network, convolution accounts for about 98% of the FLOPs, while feature accumulation and activation function contribute the rest. The mid convolutional layers in this example neural network are still dominated by convolution (about 94%), but as feature counts grow, feature accumulation carries a larger fraction of FLOPs. In fully connected layers in this example neural network, almost all FLOPs may result from vector-matrix multiplication. FIG. 5 summarizes eleven DNN benchmarks for this example neural network, the fraction of FLOPs and Bytes/FLOP for each type of computation, and where they are used in training the neural network. That is, nD-Convolution occupies 93% of the total FLOPs with about 0.15 Bytes/FLOP. Vector-matrix multiplication used in FP, BP step in fully connected layers in this example neural network accounts for 3% FLOPs and has a relatively high Bytes/FLOP ratio of 2. The third operation in this example neural network is feature accumulation in the FP, BP steps of convolutional and fully connected layers, which also adds 3% FLOPs, but has a higher Bytes/FLOP ratio of 4. The other operations, for example, activation function, sampling and vector element-wise multiplication in this example neural network contribute <0.1% each, and have the highest Bytes/FLOP. Thus, neural networks (e.g., DNNs) may include a heterogeneous set of computations (e.g., ones which occupy a significant fraction of FLOPs but with low Bytes/FLOP ratio) and the rest (e.g., which require high Bytes/FLOP but contribute only a small fraction of FLOPs).

### II. Computing Architecture

Certain embodiments herein provide for a dense, scalable compute node architecture, for example, built from the ground-up for deep networks. Certain embodiments herein provide specialized compute cores, memory hierarchy, and/or interconnect topologies, e.g., to leverage the key compute and the data flow patterns of deep networks. This section describes architectural features, for example, from which certain embodiments herein derive their efficiency.

### A. Heterogeneous Processing Tiles

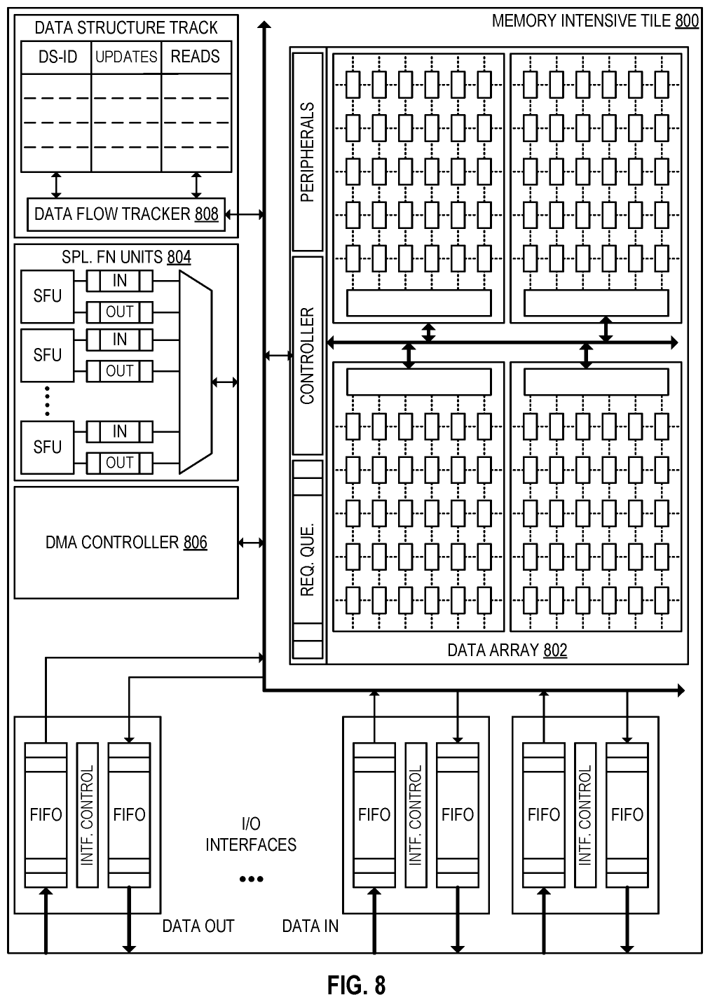

Certain embodiments herein (e.g., of a processor) aggressively exploit the heterogeneity in the computations within and across layers of a neural network. FIG. 6 illustrates the summary 600 of operations for training an example neural network according to embodiments of the disclosure. The computations in neural (e.g., deep) networks, e.g., shown in FIG. 6, may be classified into two groups: (i) operations that are compute dominant, for example, nD-convolutions and matrix multiplications, e.g., which constitute a significant fraction of the FLOPs and provide ample opportunities for data reuse (e.g., lower Bytes/FLOP) and (ii) operations that are (e.g., simple and) memory dominant (e.g., higher Bytes/FLOP ratio) for example, nD-accumulation, sub/up sampling, activation function, and vector element-wise multiplication. Certain embodiments herein utilize two types of processing tiles, a compute intensive (e.g., compute-heavy) tile and memory intensive (e.g., memory-heavy) tile, for example, to realize the compute and memory dominant computations respectively. Embodiments of the architecture of the processing tiles are discussed below.

(1) Compute Intensive Tile:

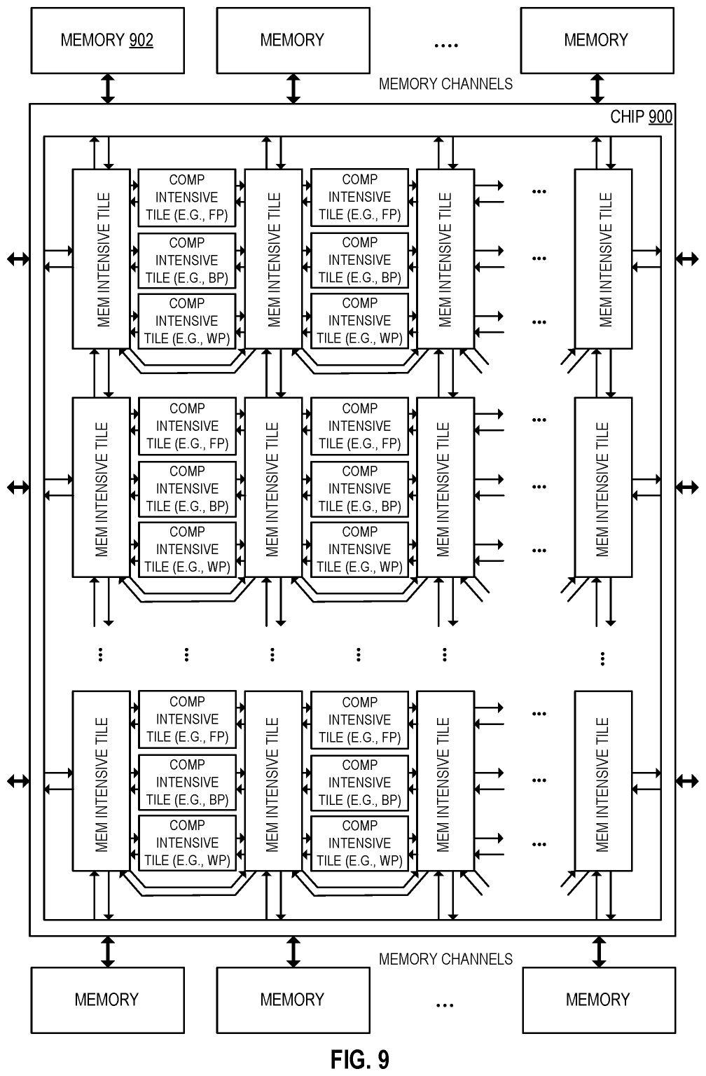

FIG. 7 illustrates a compute intensive tile 700 (e.g., circuit) according to embodiments of the disclosure. The depicted compute intensive tile 700 in FIG. 7 comprises a 2D systolic array of processing elements 701 (2D-PE array). Each 2D-PE of the array may include a vector of fused multiply and add (accumulate) (FMA) units. A 1D array of accumulators 702 is located along the right border of the 2D-PE array in FIG. 7. Three sets of memory (e.g., streaming memory (SM)) elements (704, 706, 708) are placed along the left, top, and bottom borders in FIG. 7, e.g., to feed data operands to the 2D-PEs. Compute intensive tile 700 may also contain an auxiliary memory 710, e.g., to hold temporary outputs. Other components that may be utilized in the compute intensive tile 700 include an instruction memory 718, an instruction decode and control unit 712, a scalar register file 714, and an in-order scalar processing element 716, e.g., to execute control operations such as loop counters, pointer arithmetic, branches, etc. A compute intensive tile may be optimized to carry out batch convolution (e.g., one input, many kernels) and/or matrix multiplication operations. For example, batch 2D-convolution may be realized as follows: the rows of the convolution input are fed along the rows of the 2D-PE array 701 and the kernel rows fed along the columns. Each 2D-PE may compute a function (e.g., a dot product) of an input row with a kernel row. Convolution output may be produced by diagonally accumulating the outputs (e.g., dot products) in the 1D accumulator array 702. In one embodiment, for some convolution outputs, not all rowwise outputs (e.g., dot products) are produced in the same iteration of the 2D array. In such cases for example, the partial convolution outputs may be stored in the auxiliary memory 710, e.g., and fetched back by the 1D accumulator array 702 when the remaining outputs (e.g., dot products) are available. In an embodiment where the 2D-PEs have multiple execution lanes, an equivalent number of kernels may be simultaneously fed, e.g., enabling multiple convolutions, sharing the same input, to be evaluated in parallel. Note that although the terms rows and columns are utilized, other arrangements are possible, for example, a chip may be rotated relative to the perspective in the Figures.

Array Reconfigurability. The architectural (e.g., design) parameters of a compute intensive tile may be the number of rows, columns, and lanes in the multiple dimensional (e.g., 2D) processing array, and/or the sizes of the left, top, bottom, and/or auxiliary memories. In certain embodiments, e.g., to improve utilization of compute intensive tile(s), some architectural parameters may be configured at runtime, e.g., through a circuit or software instructions. In one embodiment, the following parameters are adjustable: the columns and lanes of the 2D-PE array may be redistributed (for example, while maintaining their product constant, e.g., to dynamically increase or decrease) the number of columns in the array by proportionately reducing (or increasing) the number of lanes per 2D-PE. This configurability may be useful as feature counts and kernel sizes vary across convolutional layers, e.g., and fully connected layers involve a single matrix multiplication (e.g., the lanes to 2D-PE ration is set to 1). The 2D-PE array may be split along the rows into two 2D arrays with half the number of rows. The streaming memory elements on the left may also be split in half, e.g., while the top and bottom streaming memory elements individually feed the columns of the 2D arrays. This may allow for two batch operations (e.g., convolutions or matrix multiplications) to be executed in parallel. This configurability may be desirable to reduce the number of residual rows when the feature sizes of the convolutional layers are small, e.g., do not utilize all or most of the rows.

(2) Memory Intensive Tile:

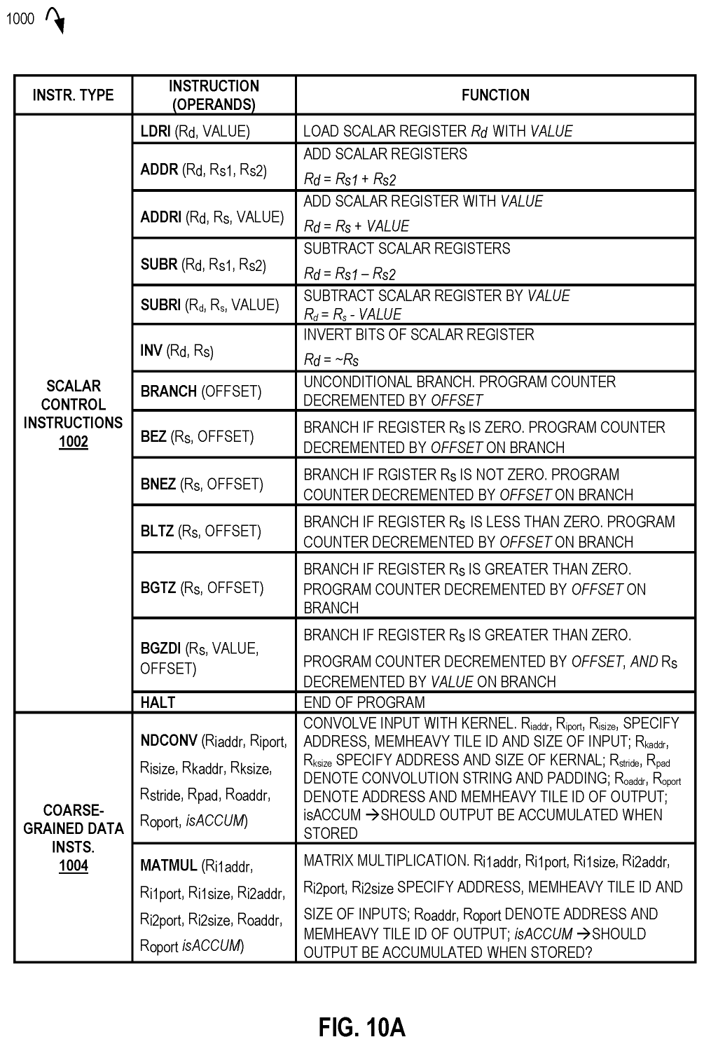

FIG. 8 illustrates a memory intensive tile 800 (e.g., circuit) according to embodiments of the disclosure. The memory intensive tile shown in FIG. 8 contains a (e.g., large) data array 802, and a vector of function units (e.g., Special Function Units 804 (SFUs)) directly interfaced to it. The SFUs 804 may contain an adder/comparator, a multiplier, and circuitry to support complex (e.g., activation) functions, e.g., tanh and sigmoid. Operations such as nD-accumulation, activation function, sub/up sampling, and/or vector element-wise multiplication may be performed in a memory intensive tile 800. Other components in the memory intensive tile 800 may include direct memory access (DMA) controllers 806, e.g., to enable data transfer to and from the data array 802. Memory intensive tile 800 may include hardware data flow trackers 808, e.g., to track selected address ranges that are read or written. In one embodiment, a processor (e.g., processing system) and/or tiles do not contain hardware-managed caches or coherence mechanisms, e.g., it may utilize these trackers to enable low-overhead synchronization between processing tiles. Hardware data flow trackers are discussed further in Section II-B4.

### B. Chip Architecture

Certain chip architectures disclosed herein combine compute intensive and memory intensive tiles (e.g., on a single chip) in a manner that leverages the data flow patterns in neural networks (e.g., DNNs). The following subsections describe embodiments of the architecture in more detail.

(1) Architecture Description:

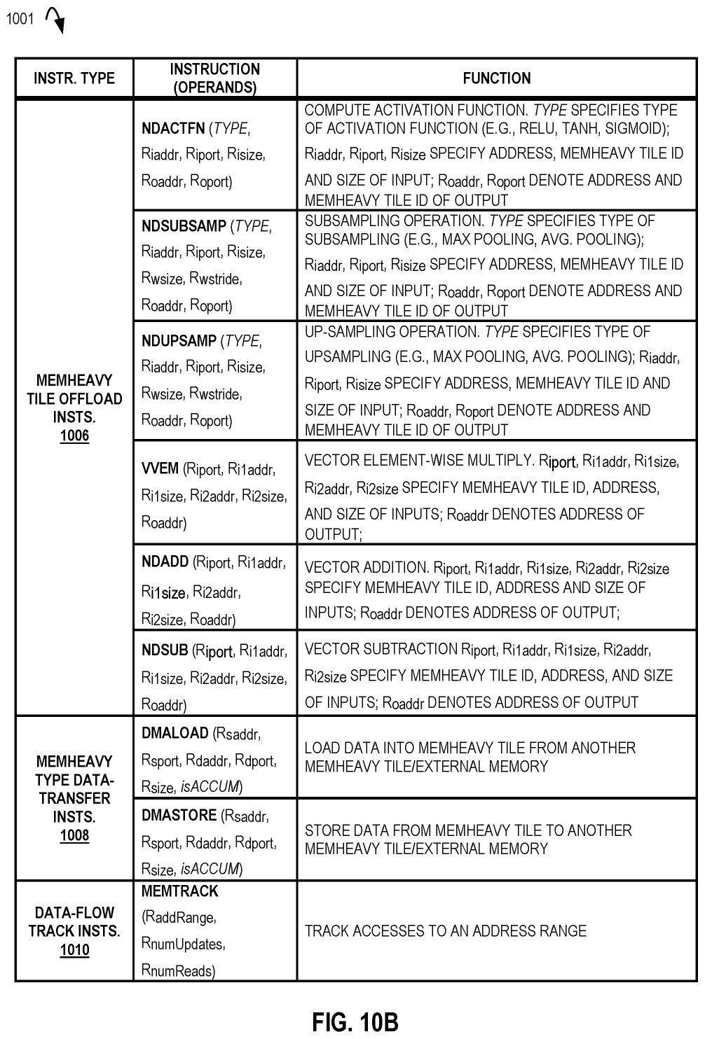

FIG. 9 illustrates a chip 900 with compute intensive tiles and memory intensive tiles according to embodiments of the disclosure. The processing tiles in FIG. 9 are arranged as a multiple dimensional (e.g., 2D) grid, with alternating columns (e.g., or rows) of compute intensive tiles and memory intensive tiles. Chip 900 includes a plurality (e.g., 3) compute intensive tiles per memory intensive tile, for example, one each for FP, BP, and WG, respectively. In the depicted embodiment, each compute intensive tile is coupled (e.g., directly connected) to memory intensive tiles on its left and right, and each memory intensive tile is coupled (e.g., directly connected) to memory intensive tiles closest to it on all directions, e.g., above and below in the same column, and left and right in adjacent memory intensive tile columns, e.g., other than the memory intensive tiles on the perimeter of chip 900. External memory chips (e.g., memory chip 902) are located above and below chip 900. Memory intensive tiles present in the top and bottom rows of the chip may each interface with one or more of the external memory chips. In one embodiment, all interconnects in a chip are point-to-point links, e.g., with no global on-chip interconnect network and/or no associated (e.g., coherency) protocol overheads.

(2) Execution Model and Instruction Set Architecture (ISA):

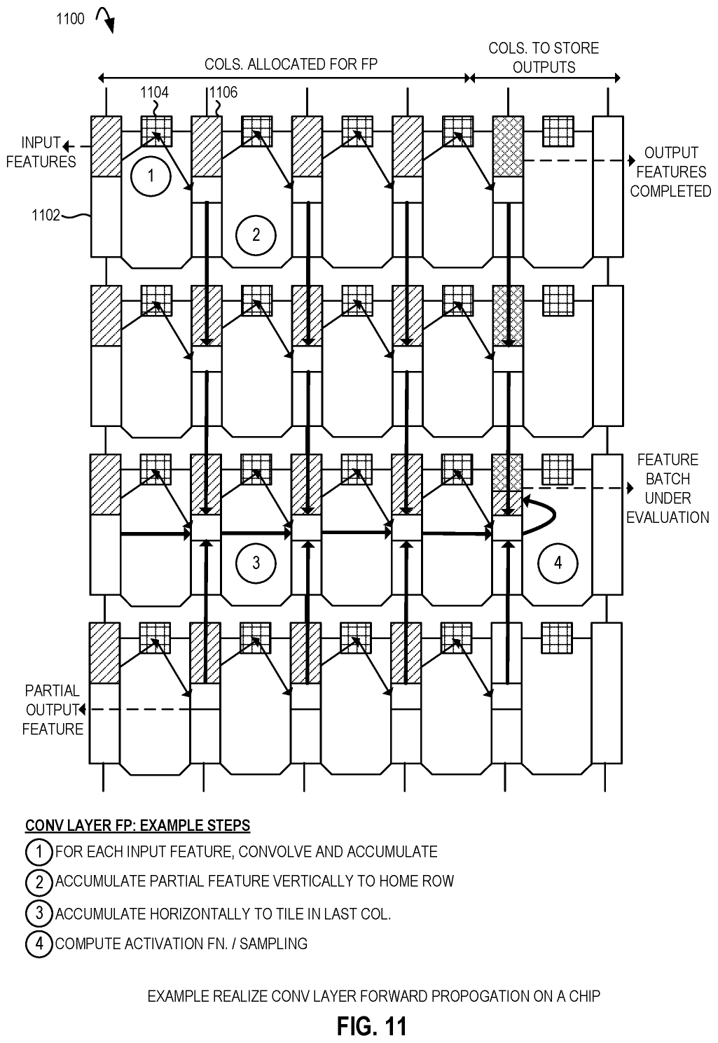

FIGS. 10A-10B illustrate instructions 1000-1001 according to embodiments of the disclosure. Certain embodiments herein (e.g., of a processor) may adopt the following execution model. Each compute intensive tile may nut (e.g., execute) a single thread of execution, e.g., whose program is stored in that tile's instruction memory. In one embodiment, the memory hierarchy is completely hardware managed, for example, with no (e.g., traditional) caches, coherence, or synchronization mechanisms. In one embodiment, the memory hierarchy is completely software managed, for example, with no (e.g., traditional) caches, coherence, or synchronization routines. One example Instruction Set Architecture (ISA) includes the 28 instructions listed in FIGS. 10A-10B. Those instructions may be grouped into 5 types:
Scalar Control Instructions 1002: e.g., load/store, scalar operations and branch instructions primarily used to determine program control flow. They may be executed on the scalar processing element (PE) of a compute intensive tile.
Coarse-grained Data Instructions 1004: e.g., compute dominant instructions such as convolutions (nD-convolutions), etc. They may be executed on the PE arrays of a compute intensive tile.
Memory Intensive Tile Offload Instructions 1006: e.g., high Bytes/FLOP instructions such as down-sampling (NDSUBSAMP) etc. They may be offloaded for execution to one of the memory intensive tiles connected to a compute intensive tile.
Memory Intensive Tile Data Transfer Instructions 1008: e.g., where the memory hierarchy is already (e.g., hardware or software) managed, these instructions may initiate data transfer between connected memory intensive tiles.
Data-flow Track Instructions 1010: e.g., instructions used to track accesses to specified data structures (e.g., address ranges). These may be used to enforce synchronized execution, for example, as explained in Section II-B4 For certain embodiments that specifically target deep networks, e.g., those whose computations and data flow are static without any (e.g., complex) data-dependent control flows, those certain embodiments may be programmed with minimal programmer burden. To this end, a circuit and/or compiler front-end may automatically map any neural (e.g., deep) network topology to a processor (e.g., processing system), for example, the processor discussed in Section II.

(3) Implementing DNN Layers on a Processor (e.g., Chip):

This disclosure now describes how DNNs are realized on an embodiment of chip architecture. Layers of the DNN may be spatially realized across the entire chip, e.g., by allocating a set of columns to each layer based on its compute and memory requirements.

Distributed Network State and Localized Computations: One key aspect of the mapping process is that (e.g., at compile time), the entire network state (e.g., features, errors, weights, and weight gradients) is partitioned and distributed across the memory intensive tiles in the chip. In one embodiment, each feature and error in the network is assigned a home memory intensive tile. Enough memory capacity may be provisioned, e.g., cumulatively across all memory intensive tiles, to hold all the features and errors of the network. In one embodiment, a neural (e.g., deep) network includes a few million neurons and utilizes 10s' of MB of memory capacity, e.g., which may be provisioned on-chip. In an embodiment when the features and errors do not fit on a single chip, the neural network may be split at the node-level and multiple chips utilized to realize the neural network. An embodiment of this is discussed in the context of the node architecture described in Section II-C. In one embodiment, e.g., depending on the memory capacity available, weights and weight gradients of selected layers are stored on-chip, e.g., in the memory intensive tiles where the corresponding features reside. Weights and gradients of the other layers may be stored in external memory, for example, and are prefetched into the memory intensive tiles (e.g., the (FIFO queue) of a memory intensive tile). The compute intensive tiles may produce and consume the neural network state stored in memory intensive tiles, e.g., those tiles directly connected to them. The SFUs present within the memory intensive tiles may also operate on the neural network state stored in them. In one embodiment, by partitioning the network state and associated computations spatially across multiple processing tiles of a chip, data movement is localized and/or interconnect bandwidth is minimized. This, e.g., coupled with a simplified memory hierarchy, may significantly add to the energy efficiency of a processor (e.g., chip).

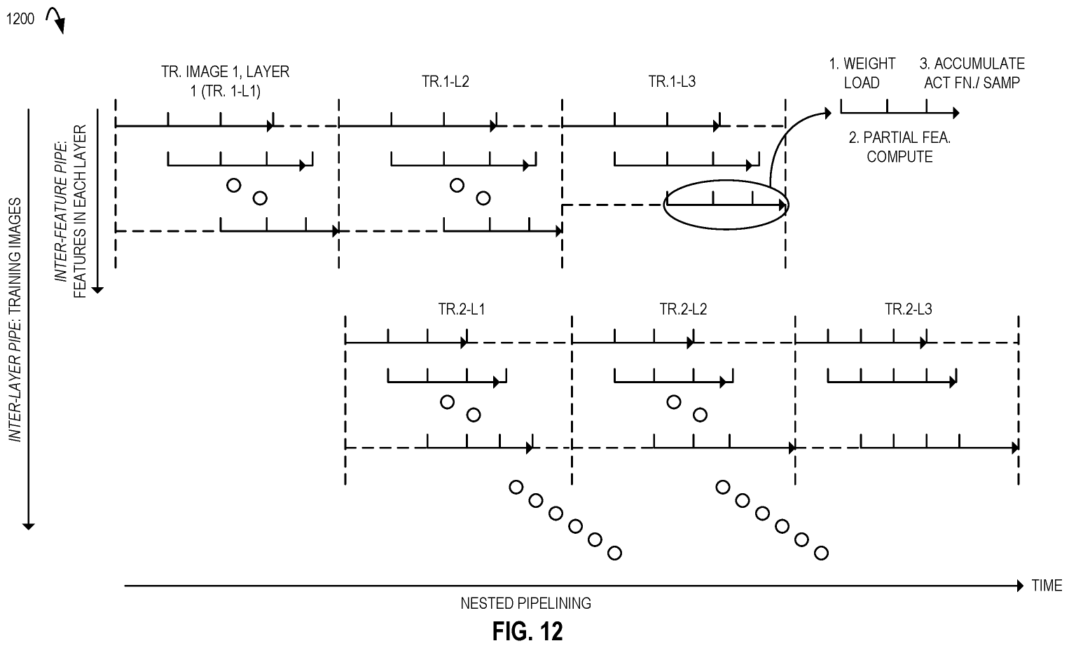

Illustration: Convolutional Layer Forward Propagation (FP): FIG. 11 illustrates the computations realized on a chip 1100 with compute intensive tiles and memory intensive tiles for the forward propagation of a convolutional layer according to embodiments of the disclosure. FIG. 11 illustrates how computations of a given layer are realized on a set of chip columns allocated to it by using the FP step of a convolutional layer as an example. Input features to the layer may be distributed evenly across the memory intensive tiles. In one embodiment, the output features produced are stored in the next set of columns, e.g., so that the next layer can be computed. The output features may be computed in batches of size equivalent to the lanes in the processing elements (e.g., 2D-Pes) of the compute intensive tile. In certain embodiments to compute each output features batch: (i) compute intensive tiles (e.g., compute intensive tile 1104) fetch an input feature from the left memory intensive tile (e.g., memory intensive tile 1102), (ii) compute intensive tile convolves the input feature to produce partial output features which are stored in the right memory intensive tile, (iii) Steps (i) and (ii) are repeated for all input features in the left memory intensive tile (e.g., memory intensive tile 1106); the right memory intensive tiles accumulate when the partial output features are stored, (iv) to produce the final weighted sum, the accumulated partial outputs in each right memory intensive tile are to be accumulated together. This may be achieved by identifying the “home” row of the output feature batch, e.g., and first accumulating the features vertically into the home row and then horizontally into the last column memory intensive tile, and (v) after this, the last-column home-row memory intensive tile may compute the activation function (e.g., and sampling if desired) before passing the output features to its home memory intensive tile. This process may be repeated until all output features are computed. If the layer weights are to be brought in from external memory, the compute intensive tile(s) may issue prefetch requests at the start of the previous output feature batch iteration.

Realizing Layer Sequences: Successive layers of a neural network (e.g., DNN) may be mapped to adjacent sets of columns in the chip. In certain embodiments, this leverages the producer and consumer relationship between layers of a neural network (e.g., DNN). In the case of FP, inputs to the DNN may be fetched from external memory by the columns that realize the first layer. From then, outputs of a layer produced by a set of columns may be consumed by the next, e.g., until the FP outputs are obtained. The final set of FP tiles may also compute the error at network outputs, e.g., by finding the difference between the golden and FP outputs. BP and WG may be realized in a similar fashion, for example, with use of their respective compute intensive tile and the direction of data flow is reversed. The weight gradients may be either stored to the external memory or on-chip. The errors may be discarded after BP/WG of the layer is complete.

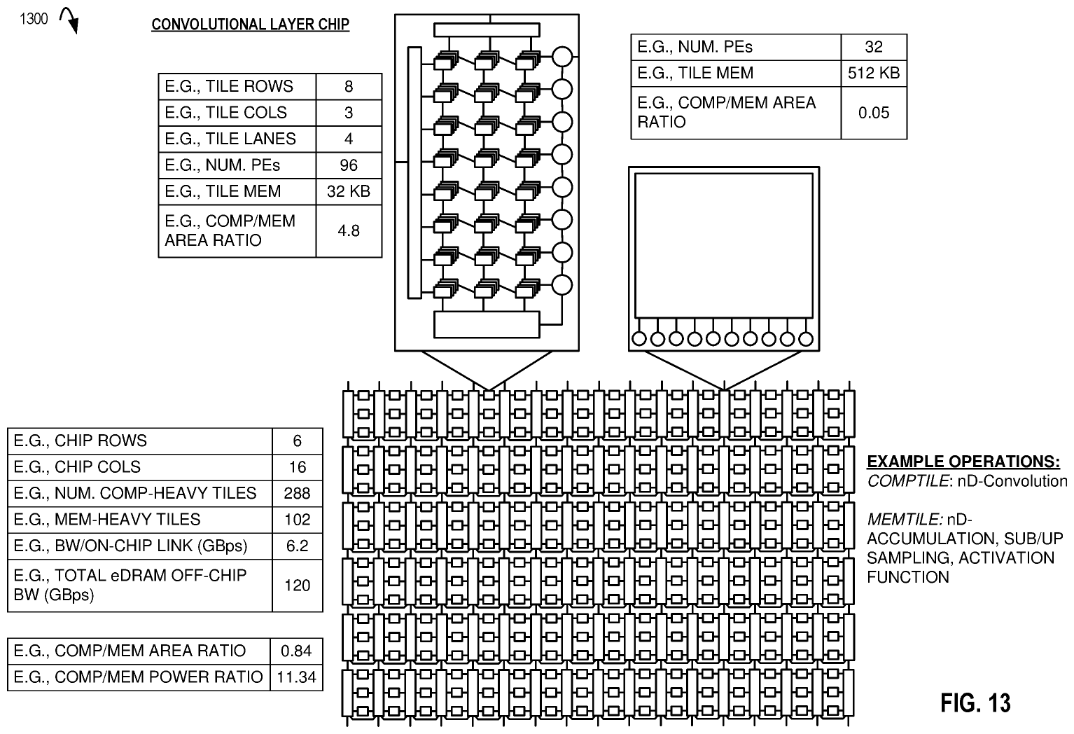

Nested Pipelining: FIG. 12 illustrates the two level nested pipelining 1200 of a chip according to embodiments of the disclosure. To improve utilization of the processing (e.g., compute intensive and memory intensive) tiles and/or hide memory latency, a chip may be programmed (e.g., through software executing on each compute intensive tile) to operate as a multiple (e.g., 2) level nested pipeline, e.g., as shown in FIG. 12. At the innermost level in FIG. 12 is the inter-feature pipeline, in which computations to evaluate an output feature batch (for example, optional weight load, partial feature output evaluation, and feature accumulation/activation function/sampling) form a multiple (e.g., 2 or 3) staged pipeline. At the outermost level in FIG. 12, is the interlayer pipeline is which (e.g., minibatch) parallelism is exploited to operate tiles corresponding to each layer on successive training (Tr.)/evaluation inputs in a pipelined manner. In this depicted case, the pipeline depth is twice the number of layers in the case of training (FP+BP/WG), and number of layers for evaluation. In one embodiment for training, the inter-layer pipeline assumes that the FP features of all layers are stored in the external memory, e.g., and fetched back when the corresponding WG step is evaluated.

(4) Synchronization Using Data Flow Trackers:

In certain embodiments, e.g., to achieve correct functionality, the programs executing on the different compute intensive tiles are to be synchronized. In certain embodiments, a full-fledged coherence protocol and/or a lock-based synchronization scheme is utilized. In certain embodiments, a full-fledged coherence protocol and/or a lock-based synchronization scheme is not used, e.g., where it imposes significant energy overheads. Certain embodiments herein leverage two key properties: (i) the data access sequence to each location in memory may be ascertained before execution (e.g., at compile time) where both the data flow in neural (e.g., deep) network and the schemes adopted to partition computations are static, and (ii) accumulation is commutative, e.g., when updates from multiple sources are accumulated at a given memory location, the end result is not affected by the order in which the updates are received. To this end, the following synchronization operation (e.g., instruction) may be used:
MEMTRACK (AddRange, NumUpdates, NumReads)
   which when (e.g., decoded and) executed, specifies an address range (AddRange) operand, an operand of the number of updates the address range should receive before it is to be read (NumUpdates), and number of reads to the address range before it is to be written (NumReads) operand. In one embodiment, the compute intensive tile offloads the MEMTRACK instruction to the appropriate memory intensive tile, for example, which then utilizes hardware counters to track accesses to the address range, e.g., to ensure the access sequence conforms to the specifications. R may refer to a register operand. In certain embodiments, the MEMTRACK operation causes hardware to deny reads and writes that violate the access sequence. Disallowing read and write transactions may be achieved by: (i) delaying the transaction by inserting it at the end of the memory queue, and retrying once it progresses to the head, or (ii) sending a deny (e.g., NACK) signal to the processing element, e.g., so that it retries the transaction at a later time. A memory intensive tile may queue up requests that arrive out of the specified order or NACK them, e.g., if the queue is full. Thus certain embodiments herein enforce synchronized execution with (e.g., very) low overhead.

(5) Heterogeneous Chip Designs:

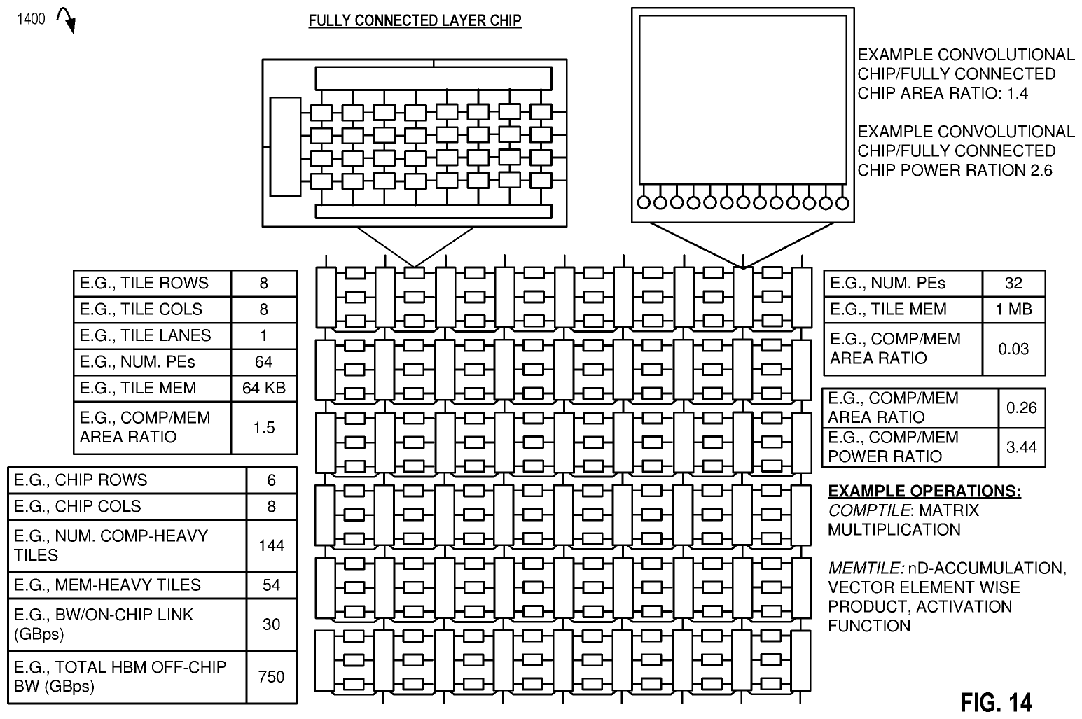

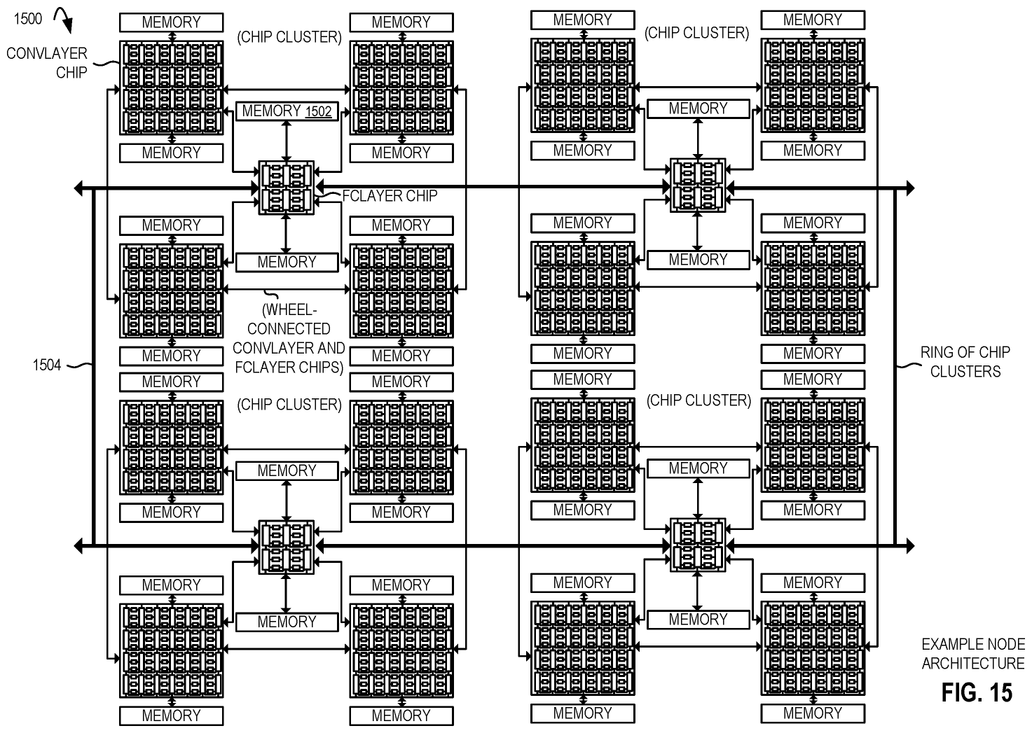

Certain embodiments use one or more components of the architectural template described above in two different chips, for example, a convolutional layer (e.g., ConvLayer) chip and fully connected layer (e.g., FCLayer) chip. FIG. 13 illustrates a convolutional layer chip 1300 according to embodiments of the disclosure. FIG. 14 illustrates a fully connected layer chip 1400 according to embodiments of the disclosure.

Certain embodiments herein use the heterogeneity between multiple layers of a neural network (e.g., the convolutional and fully connected layers of a DNN, e.g., as discussed above in reference to FIG. 5) and execute them on their respective chips. FIG. 13 and FIG. 14 respectively illustrate embodiments of a convolutional layer chip and a fully connected layer chip, e.g., where the architectural (e.g., micro-architectural) parameters are tailored to meet the compute and data requirements of the convolutional and fully connected layers. In one embodiment, the differences (e.g., illustrated in the zoomed-in tiles for each of FIGS. 13 and 14) in a convolutional layer chip and a fully connected layer chip are:
The fully connected layer chip may have fewer compute FLOPs. The compute intensive tiles have fewer 2D-PEs. For example, to cater to matrix multiplication as opposed to batch convolutions, the 2D array may have fewer rows, more columns, and each 2D-PE has only a single lane. Further, the fully connected layer chip may contain fewer columns, e.g., for a DNNs that has fewer fully connected layers than convolutional layers.
The memory arrays of the fully connected layer chip may be organized differently. For example, in a fully connected layer chip, the compute intensive tiles may have smaller auxiliary memory space and/or larger left, top, and bottom memory elements (e.g., streaming memory elements). The data array in the memory intensive tiles may be larger and/or be fewer in number owing to fewer chip columns.
The on-chip and off-chip links in the fully connected layer chip may be designed to support higher bandwidth, e.g., when fully connected layers possess a larger number of weights. Embodiments of the micro-architectural parameters of the chips and their on/off-chip bandwidth are discussed in Section IV.

### C. Node Architecture

In certain embodiments, at the node level, multiple convolutional layer and fully connected layer chips are interconnected in a two-tiered hierarchy to form a compute node. This subsection described the interconnectivity at the node-level.

(1) Chip Cluster—Wheel of Convolutional Layer and Fully Connected Layer Chips:

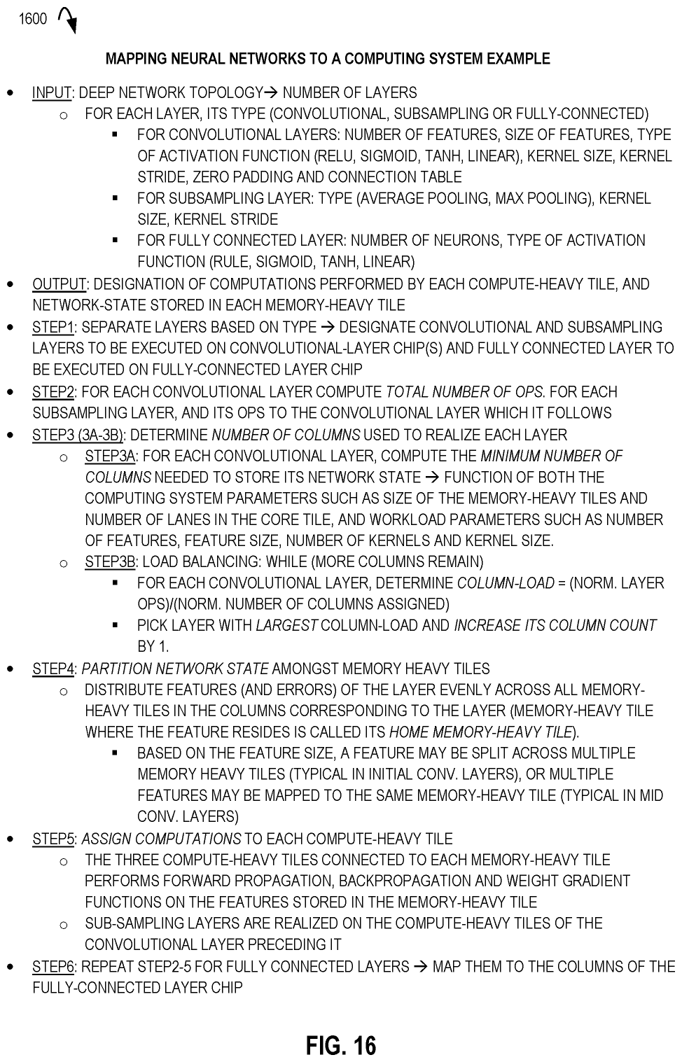

In certain embodiments, one of the key performance parameters at the node-level is for the substantially high memory bandwidth required by the fully connected layer chips to maintain a same throughput as the convolutional layer chips. One embodiment herein reduces the memory bandwidth by aggregating inputs to the fully connected layers, e.g., and execute them as a batch in the fully connected layer chip. This may allow for the layer parameters to be fetched only once per batch, e.g., reducing bandwidth proportional to the batch size. FIG. 15 illustrates an example of a computing system 1500 with a node architecture to couple a plurality of fully connected layer chips and convolutional layer chips according to embodiments of the disclosure. As shown in FIG. 15, a chip cluster is formed by connecting multiple (e.g., illustrated as four) convolutional layer chips and one fully connected layer chip as a wheel (e.g., via a wheel interconnect). The convolutional layer chips in each depicted cluster are located at the circumference and the fully connected layer chip is present at the center. The convolutional layer chips (e.g., of a cluster) may operate on different training/evaluation inputs in parallel, e.g., while the fully connected layer chip receives inputs from all the convolutional layer chips (e.g., of a cluster) and executes them in a batch. The compute capacity of the fully connected layer chip may be balanced such that it sustains the throughput of all convolutional layer chips connected to it (e.g., in that cluster). This may limit the number of convolutional layer chips in the wheel. In certain embodiments, the wheel configuration reduces the external memory utilized, e.g., as the weights of the fully connected layer may be stored only in the memory chips (e.g., memory chip 1502) connected (e.g., directly) to the fully connected layer chip. The wheel configuration may connect each convolutional layer chip to the convolutional layer chips adjacent to it. This may enable the convolutional layers to be partitioned across multiple chips in the wheel, e.g., in the case where a (e.g., convolutional) layer of a neural network does not fit be on a single convolutional layer chip. In the case of neural network training, e.g., at the end of each (e.g., minibatch) iteration, the weight gradients generated at each convolutional layer chip may be accumulated and the updated weights may be distributed using the connection (e.g., links) between the convolutional layer chips.

(2) Ring of Chip Clusters:

Multiple chip clusters may be coupled (e.g., connected) as a ring, e.g., ring 1504 in FIG. 15. The ring interconnect may allow further parallelism. Depicted ring 1504 connects each wheel through the fully connected layer chip at its center. Each wheel in the ring may operate on a different set of training and/or evaluation inputs. In the case of training, the ring may be used to accumulate weight gradients generated at each wheel and may distribute the updated weights at the end of every (e.g., minibatch) iteration. In certain embodiments, the wheel-ring configuration enables the fully connected layers to be parallelized using model parallelism, e.g., the parameters of the fully connected layers are split and stored partially in each wheel. The features and errors of the fully connected layers may be passed along the ring and evaluated at the appropriate wheel. Model parallelism may reduce or eliminate the fully connected layer weights to be sent along the ring interconnect, e.g., to greatly reduces the ring bandwidth and/or render the traffic more uniform. Model parallelism may also increase the number of inputs the fully connected layer chip processes as a batch, for example, as parts of features from all chip clusters are collected in each fully connected layer chip, e.g., in contrast to a single chip cluster. Thus embodiments herein may not just reduce the data transferred through the ring, but also lessen the memory bandwidth of each fully connected layer chip. In summary, the architectural features of certain embodiments may: (i) leverage the heterogeneity in computations by utilizing two different processing tiles and tuning a common architectural template to realize two different compute chips, (ii) incorporate a three-tiered grid-wheel-ring interconnect topology to match the data flow in neural networks (e.g., DNNs), distribute the network state and localize compute to minimize data movement, (iv) use a simplified memory hierarchy and point-to-point on-chip links to reduce memory, interconnect energies, and protocol overheads, and/or (v) exploit the static nature of data flow and commutativity of accumulations to alleviate the overheads of synchronization using data flow trackers. Thus by specializing the compute, memory, and/or interconnect subsystems, certain embodiments herein achieve significant efficiency in training and evaluating DNNs.

### III. Programming a Processor

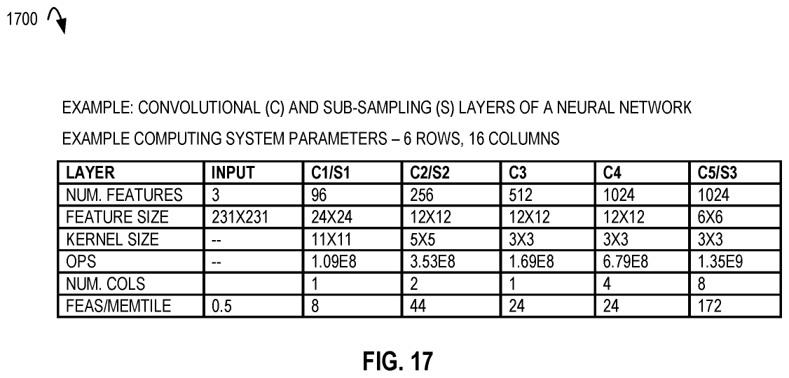

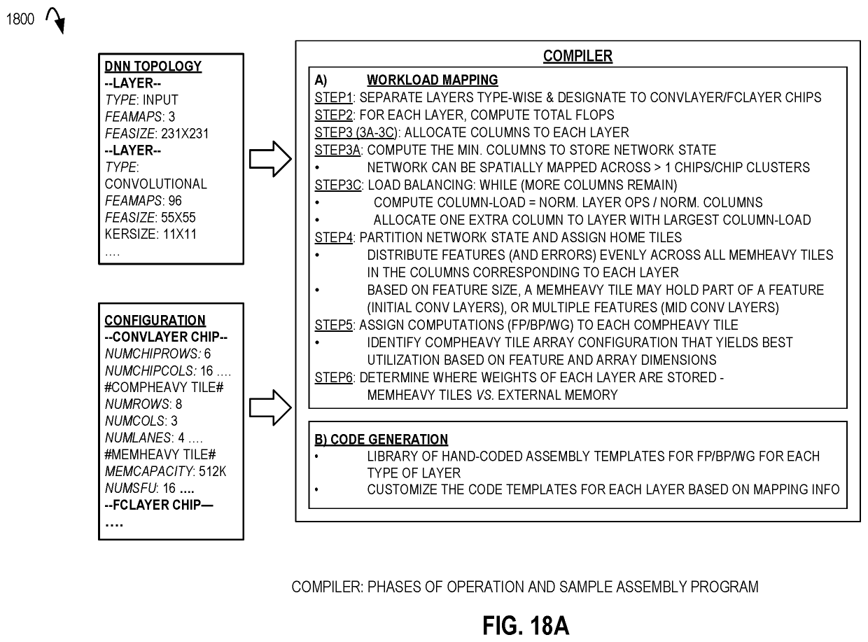

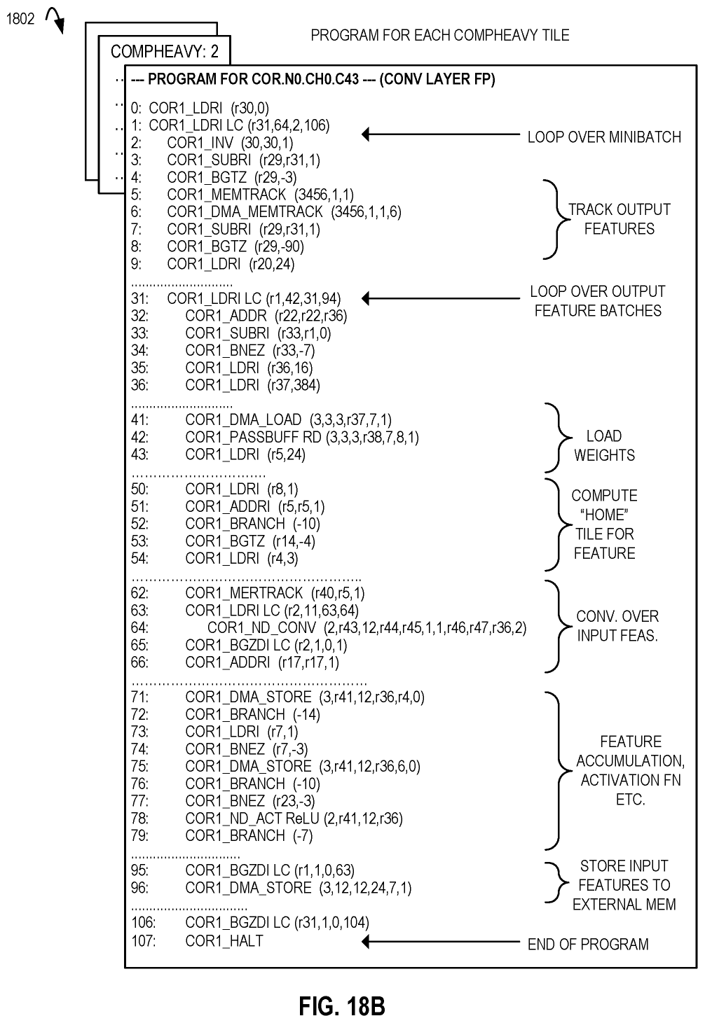

To program a processor (e.g., a processing system), for example, the processor in FIG. 15, a circuit and/or a compiler frontend take a neural network (e.g., DNN) topology and an architectural configuration as disclosed herein as its inputs, and generates code, for example, in assembly language for each compute intensive tile in the design. As shown in FIGS. 16 and 18, an example circuit and/or compiler may work in 2 phases: (i) workload mapping and (ii) code generation, embodiments of which are described in the subsections below. FIG. 16 illustrates the mapping 1600 of a neural network to a computing system according to embodiments of the disclosure. FIG. 17 illustrates an example mapping 1700 of a neural network to a computing system according to embodiments of the disclosure. FIGS. 18A-18B illustrate the mapping 1800 of a neural network to a computing system to compile code 1802 according to embodiments of the disclosure.

### A. Workload Mapping

In one embodiment, the workload mapping phase allocates chip columns for each layer in the neural network (e.g., DNN) and determines how the network state and computations are to be distributed across the memory intensive and compute intensive tiles of the allocated columns. FIGS. 16 and 18 outline embodiments of the steps involved in the workload mapping phase. First, given a DNN topology, the convolutional/SAMP layers and fully connected layers may be separated and designated to be realized on the convolutional layer and fully connected layer chips respectively (STEP1). The number of FLOPs to be used by each layer may be calculated (STEP2). The chip columns may be allocated to each layer (STEP3). To this end, the minimum number of columns to be used by each layer may first be determined, e.g., purely, based on memory constraints (STEP3a). As the execution is pipelined, the memory intensive tiles of a layer may cumulatively hold multiple (e.g., two) copies of features and errors, multiple (e.g., two) copies of partial feature/error batch under evaluation, and corresponding weights and weight gradients. Based on the minimum column constraint, the number of chips/chip clusters required to spatially map the DNN may be determined. After this, the extra columns in the chips/chip clusters may be distributed based on the compute requirements of the layers. To this end, the load per column for each layer may be computed as the ratio of the normalized FLOPs to the normalized number of columns allocated to the layer. Additional columns may be allocated to the layer with the highest column load (STEP3b). With the columns allocated, the neural (e.g., deep) network state may be distributed (e.g., evenly) across all the memory intensive tiles corresponding to each layer (STEP4). In the case of convolutional layers, e.g., based on the feature size, the memory intensive tiles may hold part of a feature or multiple features. Following this, computations may be assigned to the FP/BP/WG sets of compute intensive tiles, e.g., based on the features stored in the connected memory intensive tiles (STEP5). At this stage, the array configuration for the compute intensive tiles that yields the best utilization is to be determined (e.g., identified). Finally, e.g., based on the memory capacity available for each layer, the weights and weight gradients may be deemed to be stored either on-chip or in the external memory (STEP6).

### B. Code Generation

In certain embodiments, the code generation phase produces programs for each compute intensive tile in the processor (e.g., processing system). One embodiment of a circuit and/or compiler comprises a library of assembly templates for the FP/BP/WG steps of each layer type. These parameterized assembly templates may be customized based on the information (e.g., features per memory intensive tile) available, e.g., from the workload mapping phase. As an example, a code snippet 1802 compiled to the ISA in FIGS. 10A-10B which computes the FP step of a convolutional layer is shown in FIGS. 18A-18B. Thus the circuit and/or compiler may be used to automatically program DNNs on embodiments of the architecture disclosed herein.

### IV. Evaluation Methodology

In this section, the methodology used to evaluate certain embodiments herein is described.

Performance Evaluation: certain embodiments herein are evaluated on a detailed and cycle-accurate architectural simulator. The simulator may rigorously model (e.g., all) events that occur in each execution cycle, including every compute operation, on/offchip memory access, and data transfer.

Power and Energy Estimation: To estimate compute power, compute intensive and memory intensive tile execution arrays may be synthesized to semiconductor (e.g., 14 nm) technology node and the power measured at gate-level. The power consumed by the different components may be incorporated into the simulator, and energy estimated based on the dynamic execution traces observed during simulation.

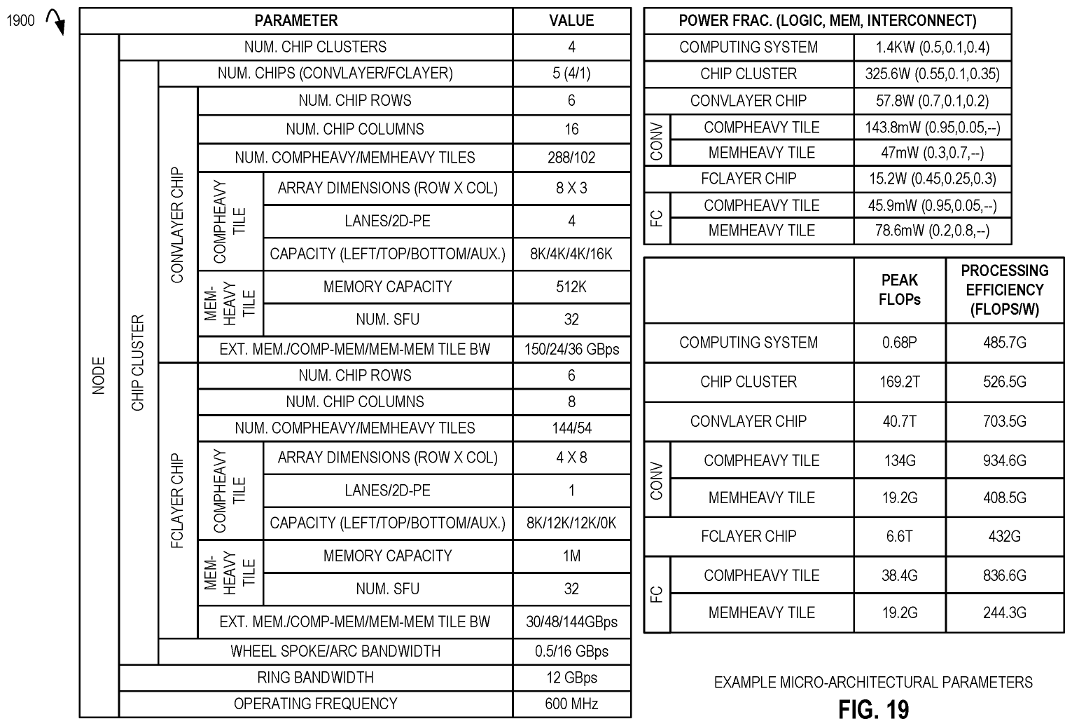

Architectural Configuration: FIG. 19 illustrates the architectural parameters 1900 of a computing system according to embodiments of the disclosure. FIG. 19 shows the (e.g., micro) architectural parameters of one (e.g., baseline) configuration. The node contains four chip clusters, e.g., with each cluster containing four convolutional layer chips and one fully connected layer chip. The convolutional layer chip may include six rows and sixteen columns with 288 compute intensive and 102 memory intensive tiles. Each compute intensive tile in the convolutional layer chip may have eight rows and three columns, for a total of twenty-four 2D-PEs with four lanes each. The data array of memory intensive tiles may be 512 KB with 32 SFU units. The on-chip links may have a bandwidth of 24-36 GBps, while each external memory may be interfaced with 150 GBps bandwidth. On the other hand, the fully connected layer chip may have six rows and eight columns, with approximately half the number of compute intensive (144) and memory intensive (54) tiles. Each compute intensive tile may also be smaller with array dimensions of 4×8 and one lane per 2D-PE. The data array of the memory intensive tile may be 1 MB in size with 32 SFU units. The fully connected layer chip's bandwidth may be 2×-4× greater than the convolutional layer chip. Example bandwidth specifications for the chip cluster- and node-level links are also listed in FIG. 19. In one embodiment, a node contains 5184 compute intensive and 1848 memory intensive tiles, and achieves 680 TFLOPS peak at its operating frequency of 600 MHz. FIG. 19 also provides a breakdown of the power consumption, peak FLOPs, and processing efficiency of the components in certain embodiments. Each convolutional layer and fully connected layer chip may consume about 58 W and about 15 W of power, respectively. This may lead to about 325 W of power consumption at the chip cluster level and 1.4 KW for the complete architectural node (e.g., processor). In one embodiment, a processor (e.g., processing system) achieves a peak processing efficiency of 485.7 GFLOPs/W, while individual compute intensive tiles reach up to 934.6 GFLOPs/W.

Benchmarks. To evaluate one embodiment of a processor, eleven image recognition DNN topologies, as noted below in Table 1, are used as the benchmarks. The benchmark networks contain between 11-39 layers (5-33 convolutional, 1-3 fully connected, 3-5 SAMP), 0.65-14.9 million neurons, and 6.8-145.9 million weights.

TABLE 1
Example DNNs

| LAYERS | NEURONS | WEIGHTS |
|---|---|---|
| (CONV/FC/SAMPLE) | (Millions) | (Millions) |
| 11 (5/3/3) | 0.65 | 60.9 |
| 11 (5/3/3) | 1.51 | 62.3 |
| 11 (5/3/3) | 1.70 | 80.4 |
| 11 (5/3/3) | 0.82 | 145.9 |
| 12 (6/3/3) | 2.05 | 144.6 |
| 17 (11/1/5) | 2.64 | 6.8 |
| 16 (8/3/5) | 7.43 | 132.8 |
| 21 (13/3/5) | 13.5 | 138.3 |
| 24 (16/3/5) | 14.9 | 143.6 |
| 23 (17/1/5) | 2.31 | 11.5 |
| 39 (33/1/5) | 3.56 | 21.1 |

### V. Example Results

In this section, we present the results that demonstrate the benefits of certain embodiments herein.

### A. Training and Evaluation Performance

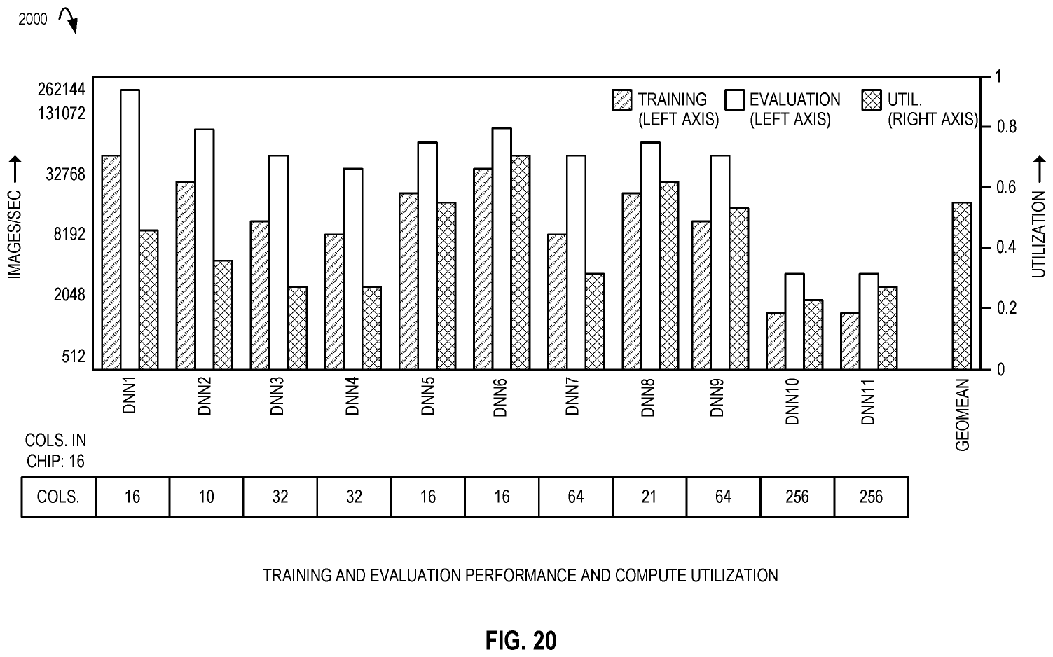

FIG. 20 illustrates example training and evaluation performance and compute utilization 2000 of a computing system according to embodiments of the disclosure. FIG. 20 may be the performance a processor (e.g., processing system) achieves in training and evaluating DNNs quantified in terms of images per second. The number of chip columns used to spatially realize the DNNs in FIG. 20 ranges between 10-256 depending on network size. This benchmark set comprises scenarios where more than one copy of the network fits on a chip to cases where the network is spread across multiple chips and chip clusters. In one embodiment, a processor (e.g., processing system) achieves a training throughput of thousands of images per second across all networks. The evaluation throughput may be higher than training by a factor marginally over 3. For example, because during evaluation, the BP/WG compute intensive tiles of certain embodiments may also be used to perform FP where the overheads of weight gradient accumulation etc., incurred at the end of each training (e.g., minibatch) do not exist.

Performance Comparison. Certain embodiments herein produce a 7×-28× increase in performance with respect to a GPU implementation.

Layer-wise Performance Analysis. FIG. 20 also shows the overall utilization of the compute elements in processing tiles. On an average, a utilization of 35% is achieved across all benchmarks in this embodiment. In certain embodiments, the sources of a drop in utilization are seen by breaking down the performance layerwise. For example, with a neural network spatially realized across chip columns and operated as a pipeline, the slowest layer may limit the overall throughput. In one embodiment for maximum utilization, the 2D-PEs are to be distributed in proportion to the FLOPs in each layer.

### B. Average Power and Processing Efficiency

The average power consumed by the different benchmarks during training of the DNN embodiments in FIG. 20, normalized to the peak value, indicate that the compute power and interconnect power scale proportionately to the 2D-PE and on/off-chip link utilizations of the benchmarks. In certain embodiments, the memory power, which is largely dominated by leakage, remains mostly constant.

### C. Bandwidth Utilization

The below discusses the utilization of the on-chip, chip cluster-level, and node-level links for each benchmark during training of the DNN embodiments in FIG. 20. In the case of on-chip links, the compute intensive-memory intensive tile links may be the best utilized (at about 0.87 utilization). The traffic through these links may be confined to carrying the input and output data for each batch convolution/matrix multiplication. On the other hand, traffic through the memory intensive-memory intensive tile links may be conditional upon factors such as number of columns a layer is mapped to, home row of the features under evaluation, and if the weights need to be fetched from off-chip. At the cluster-level, the utilization may be dictated by the overall throughput and how much the network is spread across the chips. For example, spreading the convolutional layers across two chips may reduce the convolutional layer chips' bandwidth (e.g., the weights fit on-chip, etc.), but increase the fully connected layer chip's bandwidth, e.g., as its batch size decreases by 2×. In certain embodiments, the fully connected layer bandwidth utilization may vary significantly across neural networks. For example, DNN3-4 and DNN7 may contain a single fully connected layer with small number of inputs (e.g., in contrast to DNN6 and DNN8-11), e.g., which drastically reduces their bandwidth. In certain embodiments, DNNs whose convolutional layers fit on a single chip may have minimal use for the arcs of the wheel (e.g., only to distribute weights after an (e.g., minibatch) iteration), while spoke utilization of the wheel may be determined by the inputs to the first fully connected layer. At the node-level, the utilization of the ring may be small for the DDNs in FIG. 20 except DNN10-11, e.g., which are spatially mapped across multiple chip clusters. There, e.g., in addition to convolutional weights and fully connected features/errors, the ring may carry convolutional features/errors, which may be relatively large.

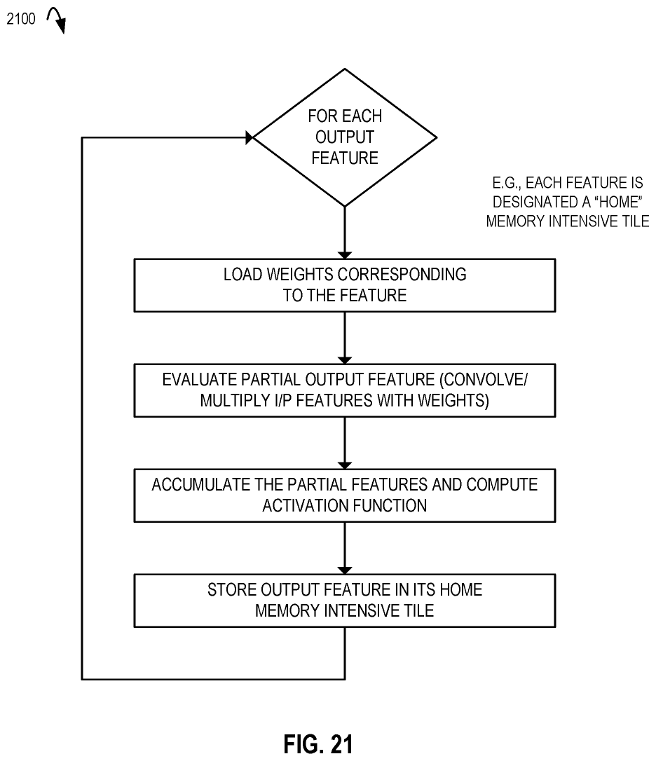

FIG. 21 illustrates a flow diagram 2100 to evaluate each feature of a layer according to embodiments of this disclosure.

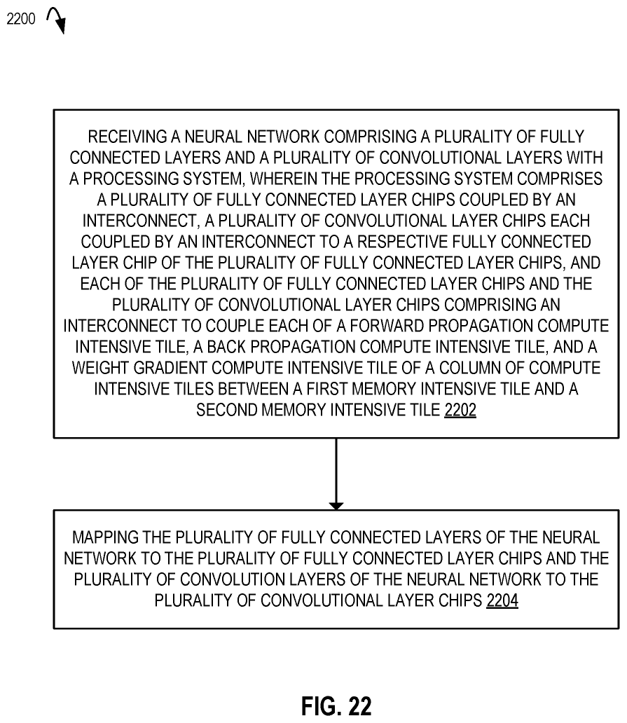

FIG. 22 illustrates a flow diagram according to embodiments of the disclosure. Flow 2200 includes receiving a neural network comprising a plurality of fully connected layers and a plurality of convolutional layers with a processing system, wherein the processing system comprises a plurality of fully connected layer chips coupled by an interconnect, a plurality of convolutional layer chips each coupled by an interconnect to a respective fully connected layer chip of the plurality of fully connected layer chips, and each of the plurality of fully connected layer chips and the plurality of convolutional layer chips comprising an interconnect to couple each of a forward propagation compute intensive tile, a back propagation compute intensive tile, and a weight gradient compute intensive tile of a column of compute intensive tiles between a first memory intensive tile and a second memory intensive tile 2202, and mapping the plurality of fully connected layers of the neural network to the plurality of fully connected layer chips and the plurality of convolution layers of the neural network to the plurality of convolutional layer chips 2204.

The advent of (e.g., deep) neural networks across the spectrum of computing devices, from mobile to cloud, allows for implementation efficiency with certain embodiments herein, for example, a specialized node architecture for training and evaluating DNNs. The architecture may include heterogeneous processing tiles, for example, compute intensive tile and memory intensive tiles, and compute chips for example, convolutional layer chip and fully connected layer chip, e.g., interconnected using a 3-tiered grid-wheel-ring topology. Embodiments herein leverage the computation and communication patterns prevalent in DNNs. Certain embodiments herein map a (e.g., any) DNN topology to a processor that distributes network state to localize compute and data movement, e.g., and improves utilization through nested pipelining Certain embodiments herein provide an order of magnitude improvement in performance and energy efficiency. Certain embodiments herein may be trained for a DNN in less than one or two days.

Certain embodiments herein specialize all the subsystems, including the compute cores, memory hierarchy, and interconnect topology so as to leverage the key computation and data access patterns in DNNs, e.g., leading to drastic improvements in performance and energy efficiency. Certain embodiments herein (for example, a processor (e.g., processing system)) target both training and evaluation of DNNs, e.g., in contrast to exclusively focusing on network evaluation. Certain embodiments herein target a different implementation context than stand-alone accelerator cores. Certain embodiments herein provide a scalable node-level architecture utilizing many (e.g., thousands) of such processing cores, and how best to partition computations amongst them to optimize core utilization, memory bandwidth, and reduce synchronization overheads. Example architectural features from which certain embodiments herein derive their performance/efficiency are: heterogeneous processing tiles and compute chips that aggressively exploit the varying computational characteristics of DNNs both within a layer and across layers, a 3-tiered grid-wheel-ring interconnect topology that matches the communication characteristics of certain DNNs, methods to map DNNs to architecture that localizes computations to minimize data movement, and improves core utilization through nested pipelining, and a low-overhead scheme to enforce synchronized execution using hardware data-flow trackers.

In certain embodiments, one, a plurality (e.g., subset), or all of the above features may be utilized in a processor. In another embodiment, the compute intensive and memory intensive tiles may be replaced with a processing core and a (e.g., Basic Linear Algebra Subprograms (BLAS)) accelerator, respectively, that utilize the interconnect topology and mapping strategy discussed herein.

In one embodiment, an apparatus to process a neural network includes a plurality of fully connected layer chips coupled by an interconnect; a plurality of convolutional layer chips each coupled by an interconnect to a respective fully connected layer chip of the plurality of fully connected layer chips; and each of the plurality of fully connected layer chips and the plurality of convolutional layer chips includes an interconnect to couple each of a forward propagation compute intensive tile, a back propagation compute intensive tile, and a weight gradient compute intensive tile of a column of compute intensive tiles between a first memory intensive tile and a second memory intensive tile. Each of the plurality of fully connected layer chips and the plurality of convolutional layer chips may include a plurality of rows and columns of compute intensive tiles coupled to a plurality of rows and columns of memory intensive tiles. Each memory intensive tile may include storage for a multiple dimensional data array and a plurality of functional units coupled to the storage. Each compute intensive tile may include a multiple dimensional array of processing elements. The forward propagation compute intensive tile, the back propagation compute intensive tile, and the weight gradient compute intensive tile may fetch an input feature from the first memory intensive tile and store an output feature into the second memory intensive tile. Partial output features from the compute intensive tiles may be accumulated into a third memory intensive tile to compute an activation function. A convolution layer chip may operate on a set of inputs in parallel to generate updated weight gradients and a respective fully connected layer chip is to operate on a set of outputs from the convolution layer chip. The apparatus to process the neural network may include a circuit to map fully connected layers of the neural network to the plurality of fully connected layer chips and map convolution layers of the neural network to the plurality of convolutional layer chips.

In one embodiment, an apparatus to process a neural network includes a plurality of fully connected layer chips coupled by a ring interconnect; a plurality of convolutional layer chips each coupled by a wheel interconnect to a respective fully connected layer chip of the plurality of fully connected layer chips; and each of the plurality of fully connected layer chips and the plurality of convolutional layer chips comprises a multiple dimensional grid interconnect coupling columns of compute intensive tiles to columns of memory intensive tiles, with a forward propagation compute intensive tile, a back propagation compute intensive tile, and a weight gradient compute intensive tile of the compute intensive tiles each coupled between a first memory intensive tile and a second memory intensive tile of the memory intensive tiles.

In another embodiment, a method includes receiving a neural network comprising a plurality of fully connected layers and a plurality of convolutional layers with a processing system, wherein the processing system comprises a plurality of fully connected layer chips coupled by an interconnect, a plurality of convolutional layer chips each coupled by an interconnect to a respective fully connected layer chip of the plurality of fully connected layer chips, and each of the plurality of fully connected layer chips and the plurality of convolutional layer chips comprising an interconnect to couple each of a forward propagation compute intensive tile, a back propagation compute intensive tile, and a weight gradient compute intensive tile of a column of compute intensive tiles between a first memory intensive tile and a second memory intensive tile; and mapping the plurality of fully connected layers of the neural network to the plurality of fully connected layer chips and the plurality of convolution layers of the neural network to the plurality of convolutional layer chips. The method may include generating updated weight gradients for the neural network with the processing system. The method may include a convolution layer chip operating on a set of inputs in parallel to generate updated weight gradients and a respective fully connected layer chip operating on a set of outputs from the convolution layer chip. The method may include accumulating partial output features from the compute intensive tiles into a third memory intensive tile, and computing an activation function. The method may include each of the plurality of fully connected layer chips and the plurality of convolutional layer chips including a plurality of rows and columns of compute intensive tiles coupled to a plurality of rows and columns of memory intensive tiles, and the mapping including allocating columns for each layer of the neural network to the memory intensive tiles. The mapping may include distributing errors of each layer across its allocated columns of the memory intensive tiles. The mapping may include distributing features of each layer across its allocated columns of the memory intensive tiles. The mapping may include assigning computation of a forward propagation function, a back propagation function, and a weight gradient function to a forward propagation compute intensive tile, a back propagation compute intensive tile, and a weight gradient compute intensive tile of the plurality of rows and columns of compute intensive tiles.

In yet another embodiment, a non-transitory machine readable medium that stores code that when executed by a machine causes the machine to perform a method including receiving a neural network comprising a plurality of fully connected layers and a plurality of convolutional layers with a processing system, wherein the processing system comprises a plurality of fully connected layer chips coupled by an interconnect, a plurality of convolutional layer chips each coupled by an interconnect to a respective fully connected layer chip of the plurality of fully connected layer chips, and each of the plurality of fully connected layer chips and the plurality of convolutional layer chips comprising an interconnect to couple each of a forward propagation compute intensive tile, a back propagation compute intensive tile, and a weight gradient compute intensive tile of a column of compute intensive tiles between a first memory intensive tile and a second memory intensive tile; and mapping the plurality of fully connected layers of the neural network to the plurality of fully connected layer chips and the plurality of convolution layers of the neural network to the plurality of convolutional layer chips. The method may include generating updated weight gradients for the neural network with the processing system. The method may include a convolution layer chip operating on a set of inputs in parallel to generate updated weight gradients and a respective fully connected layer chip operating on a set of outputs from the convolution layer chip. The method may include accumulating partial output features from the compute intensive tiles into a third memory intensive tile, and computing an activation function. The method may include each of the plurality of fully connected layer chips and the plurality of convolutional layer chips including a plurality of rows and columns of compute intensive tiles coupled to a plurality of rows and columns of memory intensive tiles, and the mapping including allocating columns for each layer of the neural network to the memory intensive tiles. The mapping may include distributing errors of each layer across its allocated columns of the memory intensive tiles. The mapping may include distributing features of each layer across its allocated columns of the memory intensive tiles. The mapping may include assigning computation of a forward propagation function, a back propagation function, and a weight gradient function to a forward propagation compute intensive tile, a back propagation compute intensive tile, and a weight gradient compute intensive tile of the plurality of rows and columns of compute intensive tiles.

In another embodiment, an apparatus to process a neural network includes a plurality of fully connected layer means coupled by an interconnect; a plurality of convolutional layer means each coupled by an interconnect to a respective fully connected layer means of the plurality of fully connected layer means; and each of the plurality of fully connected layer means and the plurality of convolutional layer means includes an interconnect to couple each of a forward propagation compute intensive means, a back propagation compute intensive means, and a weight gradient compute intensive means of a column of compute intensive means between a first memory intensive means and a second memory intensive means. Each of the plurality of fully connected layer means and the plurality of convolutional layer means may include a plurality of rows and columns of compute intensive means coupled to a plurality of rows and columns of memory intensive means. Each memory intensive means may include storage for a multiple dimensional data array and a plurality of functional units coupled to the storage. Each compute intensive means may include a multiple dimensional array of processing elements. The forward propagation compute intensive means, the back propagation compute intensive means, and the weight gradient compute intensive means may fetch an input feature from the first memory intensive means and store an output feature into the second memory intensive means. Partial output features from the compute intensive means may be accumulated into a third memory intensive means to compute an activation function. A convolution layer means may operate on a set of inputs in parallel to generate updated weight gradients and a respective fully connected layer means is to operate on a set of outputs from the convolution layer means. The apparatus to process the neural network may include a circuit to map fully connected layers of the neural network to the plurality of fully connected layer means and map convolution layers of the neural network to the plurality of convolutional layer means.

In yet another embodiment, an apparatus comprises a data storage device that stores code that when executed by a hardware processor causes the hardware processor to perform any method disclosed herein. An apparatus may be as described in the detailed description. A method may be as described in the detailed description.

In another embodiment, a non-transitory machine readable medium that stores code that when executed by a machine causes the machine to perform a method comprising any method disclosed herein.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, June 2016; and see Intel® Architecture Instruction Set Extensions Programming Reference, February 2016).

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

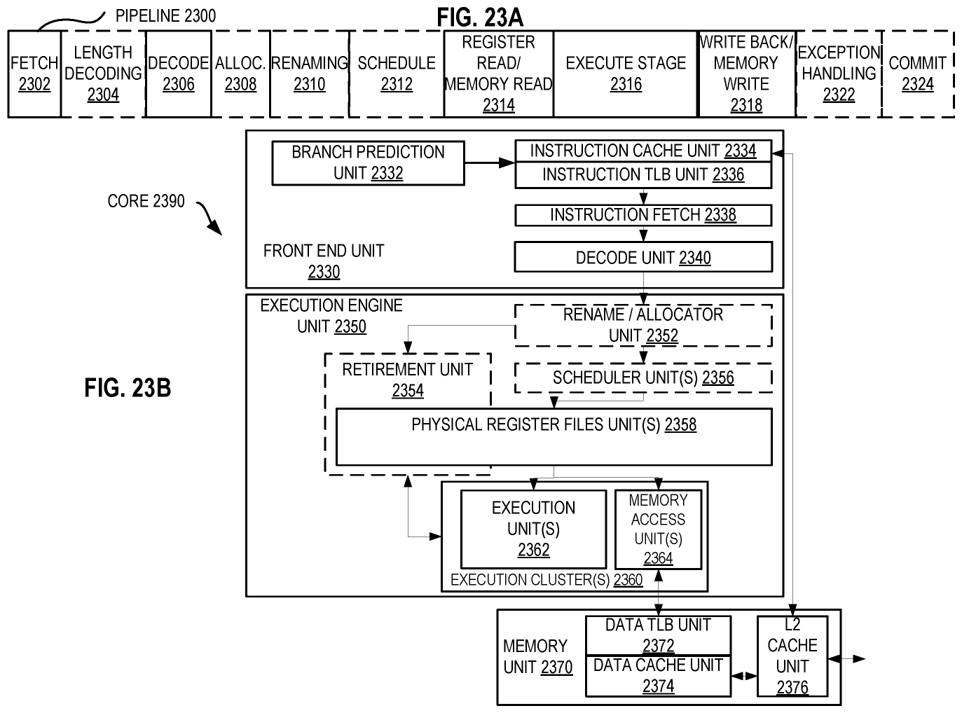

FIG. 23A is a block diagram illustrating both an exemplary in-order pipeline and an exemplary register renaming, out-of-order issue/execution pipeline according to embodiments of the disclosure. FIG. 23B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 23A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 23A, a processor pipeline 2300 includes a fetch stage 2302, a length decode stage 2304, a decode stage 2306, an allocation stage 2308, a renaming stage 2310, a scheduling (also known as a dispatch or issue) stage 2312, a register read/memory read stage 2314, an execute stage 2316, a write back/memory write stage 2318, an exception handling stage 2322, and a commit stage 2324.

FIG. 23B shows processor core 2390 including a front end unit 2330 coupled to an execution engine unit 2350, and both are coupled to a memory unit 2370. The core 2390 may be a reduced instruction set computing (RISC) core, a complex instruction set computing (CISC) core, a very long instruction word (VLIW) core, or a hybrid or alternative core type. As yet another option, the core 2390 may be a special-purpose core, such as, for example, a network or communication core, compression engine, coprocessor core, general purpose computing graphics processing unit (GPGPU) core, graphics core, or the like.

The front end unit 2330 includes a branch prediction unit 2332 coupled to an instruction cache unit 2334, which is coupled to an instruction translation lookaside buffer (TLB) 2336, which is coupled to an instruction fetch unit 2338, which is coupled to a decode unit 2340. The decode unit 2340 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 2340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 2390 includes a microcode ROM or other medium that stores microcode for certain macroinstructions (e.g., in decode unit 2340 or otherwise within the front end unit 2330). The decode unit 2340 is coupled to a rename/allocator unit 2352 in the execution engine unit 2350.

The execution engine unit 2350 includes the rename/allocator unit 2352 coupled to a retirement unit 2354 and a set of one or more scheduler unit(s) 2356. The scheduler unit(s) 2356 represents any number of different schedulers, including reservations stations, central instruction window, etc. The scheduler unit(s) 2356 is coupled to the physical register file(s) unit(s) 2358. Each of the physical register file(s) units 2358 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 2358 comprises a vector registers unit, a write mask registers unit, and a scalar registers unit. These register units may provide architectural vector registers, vector mask registers, and general purpose registers. The physical register file(s) unit(s) 2358 is overlapped by the retirement unit 2354 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 2354 and the physical register file(s) unit(s) 2358 are coupled to the execution cluster(s) 2360. The execution cluster(s) 2360 includes a set of one or more execution units 2362 and a set of one or more memory access units 2364. The execution units 2362 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 2356, physical register file(s) unit(s) 2358, and execution cluster(s) 2360 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 2364). It should also be understood that where separate pipelines are used, one or more of these pipelines may be out-of-order issue/execution and the rest in-order.

The set of memory access units 2364 is coupled to the memory unit 2370, which includes a data TLB unit 2372 coupled to a data cache unit 2374 coupled to a level 2 (L2) cache unit 2376. In one exemplary embodiment, the memory access units 2364 may include a load unit, a store address unit, and a store data unit, each of which is coupled to the data TLB unit 2372 in the memory unit 2370. The instruction cache unit 2334 is further coupled to a level 2 (L2) cache unit 2376 in the memory unit 2370. The L2 cache unit 2376 is coupled to one or more other levels of cache and eventually to a main memory.

By way of example, the exemplary register renaming, out-of-order issue/execution core architecture may implement the pipeline 2300 as follows: 1) the instruction fetch 2338 performs the fetch and length decoding stages 2302 and 2304; 2) the decode unit 2340 performs the decode stage 2306; 3) the rename/allocator unit 2352 performs the allocation stage 2308 and renaming stage 2310; 4) the scheduler unit(s) 2356 performs the schedule stage 2312; 5) the physical register file(s) unit(s) 2358 and the memory unit 2370 perform the register read/memory read stage 2314; the execution cluster 2360 perform the execute stage 2316; 6) the memory unit 2370 and the physical register file(s) unit(s) 2358 perform the write back/memory write stage 2318; 7) various units may be involved in the exception handling stage 2322; and 8) the retirement unit 2354 and the physical register file(s) unit(s) 2358 perform the commit stage 2324.

The core 2390 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 2390 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 2334/2374 and a shared L2 cache unit 2376, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

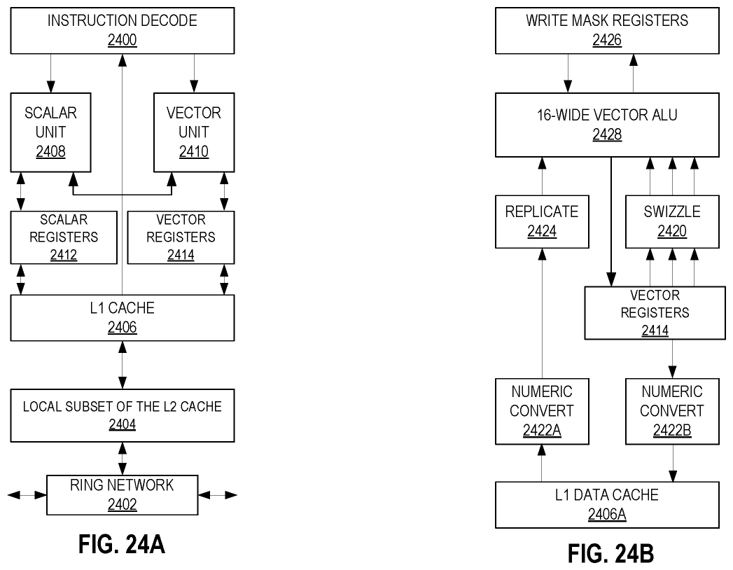

FIGS. 24A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 24A is a block diagram of a single processor core, along with its connection to the on-die interconnect network 2402 and with its local subset of the Level 2 (L2) cache 2404, according to embodiments of the disclosure. In one embodiment, an instruction decode unit 2400 supports the x86 instruction set with a packed data instruction set extension. An L1 cache 2406 allows low-latency accesses to cache memory into the scalar and vector units. While in one embodiment (to simplify the design), a scalar unit 2408 and a vector unit 2410 use separate register sets (respectively, scalar registers 2412 and vector registers 2414) and data transferred between them is written to memory and then read back in from a level 1 (L1) cache 2406, alternative embodiments of the disclosure may use a different approach (e.g., use a single register set or include a communication path that allow data to be transferred between the two register files without being written and read back).

The local subset of the L2 cache 2404 is part of a global L2 cache that is divided into separate local subsets, one per processor core. Each processor core has a direct access path to its own local subset of the L2 cache 2404. Data read by a processor core is stored in its L2 cache subset 2404 and can be accessed quickly, in parallel with other processor cores accessing their own local L2 cache subsets. Data written by a processor core is stored in its own L2 cache subset 2404 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 24B is an expanded view of part of the processor core in FIG. 24A according to embodiments of the disclosure. FIG. 24B includes an L1 data cache 2406A part of the L1 cache 2406, as well as more detail regarding the vector unit 2410 and the vector registers 2414. Specifically, the vector unit 2410 is a 16-wide vector processing unit (VPU) (see the 16-wide ALU 2428), which executes one or more of integer, single-precision float, and double-precision float instructions. The VPU supports swizzling the register inputs with swizzle unit 2420, numeric conversion with numeric convert units 2422A-B, and replication with replication unit 2424 on the memory input. Write mask registers 2426 allow predicating resulting vector writes.

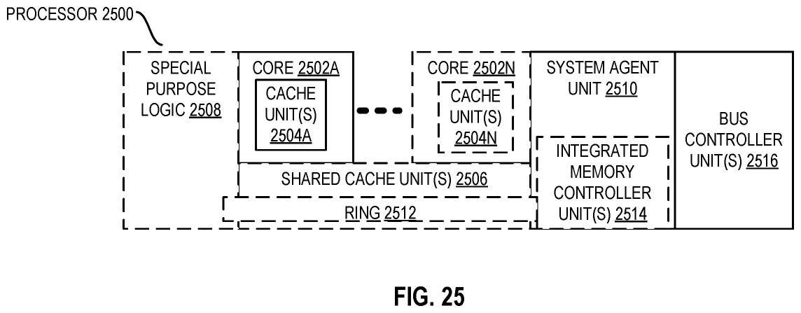

FIG. 25 is a block diagram of a processor 2500 that may have more than one core, may have an integrated memory controller, and may have integrated graphics according to embodiments of the disclosure. The solid lined boxes in FIG. 25 illustrate a processor 2500 with a single core 2502A, a system agent 2510, a set of one or more bus controller units 2516, while the optional addition of the dashed lined boxes illustrates an alternative processor 2500 with multiple cores 2502A-N, a set of one or more integrated memory controller unit(s) 2514 in the system agent unit 2510, and special purpose logic 2508.

Thus, different implementations of the processor 2500 may include: 1) a CPU with the special purpose logic 2508 being integrated graphics and/or scientific (throughput) logic (which may include one or more cores), and the cores 2502A-N being one or more general purpose cores (e.g., general purpose in-order cores, general purpose out-of-order cores, a combination of the two); 2) a coprocessor with the cores 2502A-N being a large number of special purpose cores intended primarily for graphics and/or scientific (throughput); and 3) a coprocessor with the cores 2502A-N being a large number of general purpose in-order cores. Thus, the processor 2500 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 2500 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 2506, and external memory (not shown) coupled to the set of integrated memory controller units 2514. The set of shared cache units 2506 may include one or more mid-level caches, such as level 2 (L2), level 3 (L3), level 4 (L4), or other levels of cache, a last level cache (LLC), and/or combinations thereof. While in one embodiment a ring based interconnect unit 2512 interconnects the integrated graphics logic 2508, the set of shared cache units 2506, and the system agent unit 2510/integrated memory controller unit(s) 2514, alternative embodiments may use any number of well-known techniques for interconnecting such units. In one embodiment, coherency is maintained between one or more cache units 2506 and cores 2502-A-N.

In some embodiments, one or more of the cores 2502A-N are capable of multithreading. The system agent 2510 includes those components coordinating and operating cores 2502A-N. The system agent unit 2510 may include for example a power control unit (PCU) and a display unit. The PCU may be or include logic and components needed for regulating the power state of the cores 2502A-N and the integrated graphics logic 2508. The display unit is for driving one or more externally connected displays.

The cores 2502A-N may be homogenous or heterogeneous in terms of architecture instruction set; that is, two or more of the cores 2502A-N may be capable of execution the same instruction set, while others may be capable of executing only a subset of that instruction set or a different instruction set.

### Exemplary Computer Architectures

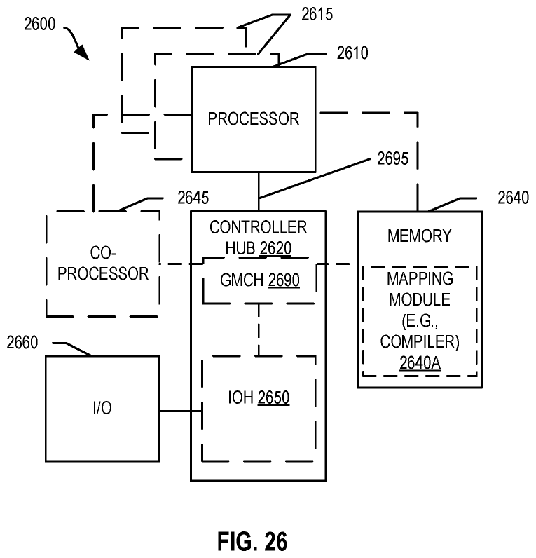

FIGS. 26-29 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 26, shown is a block diagram of a system 2600 in accordance with one embodiment of the present disclosure. The system 2600 may include one or more processors 2610, 2615, which are coupled to a controller hub 2620. In one embodiment the controller hub 2620 includes a graphics memory controller hub (GMCH) 2690 and an Input/Output Hub (IOH) 2650 (which may be on separate chips); the GMCH 2690 includes memory and graphics controllers to which are coupled memory 2640 and a coprocessor 2645; the IOH 2650 couples input/output (I/O) devices 2660 to the GMCH 2690. Alternatively, one or both of the memory and graphics controllers are integrated within the processor (as described herein), the memory 2640 and the coprocessor 2645 are coupled directly to the processor 2610, and the controller hub 2620 in a single chip with the IOH 2650. Memory 2640 may include a mapping module 2640A, for example, to store code that when executed causes a processor to perform any method of this disclosure.

The optional nature of additional processors 2615 is denoted in FIG. 26 with broken lines. Each processor 2610, 2615 may include one or more of the processing cores described herein and may be some version of the processor 2500.

The memory 2640 may be, for example, dynamic random access memory (DRAM), phase change memory (PCM), or a combination of the two. For at least one embodiment, the controller hub 2620 communicates with the processor(s) 2610, 2615 via a multi-drop bus, such as a frontside bus (FSB), point-to-point interface such as QuickPath Interconnect (QPI), or similar connection 2695.

In one embodiment, the coprocessor 2645 is a special-purpose processor, such as, for example, a high-throughput MIC processor, a network or communication processor, compression engine, graphics processor, GPGPU, embedded processor, or the like. In one embodiment, controller hub 2620 may include an integrated graphics accelerator.

There can be a variety of differences between the physical resources 2610, 2615 in terms of a spectrum of metrics of merit including architectural, microarchitectural, thermal, power consumption characteristics, and the like.

In one embodiment, the processor 2610 executes instructions that control data processing operations of a general type. Embedded within the instructions may be coprocessor instructions. The processor 2610 recognizes these coprocessor instructions as being of a type that should be executed by the attached coprocessor 2645. Accordingly, the processor 2610 issues these coprocessor instructions (or control signals representing coprocessor instructions) on a coprocessor bus or other interconnect, to coprocessor 2645. Coprocessor(s) 2645 accept and execute the received coprocessor instructions.

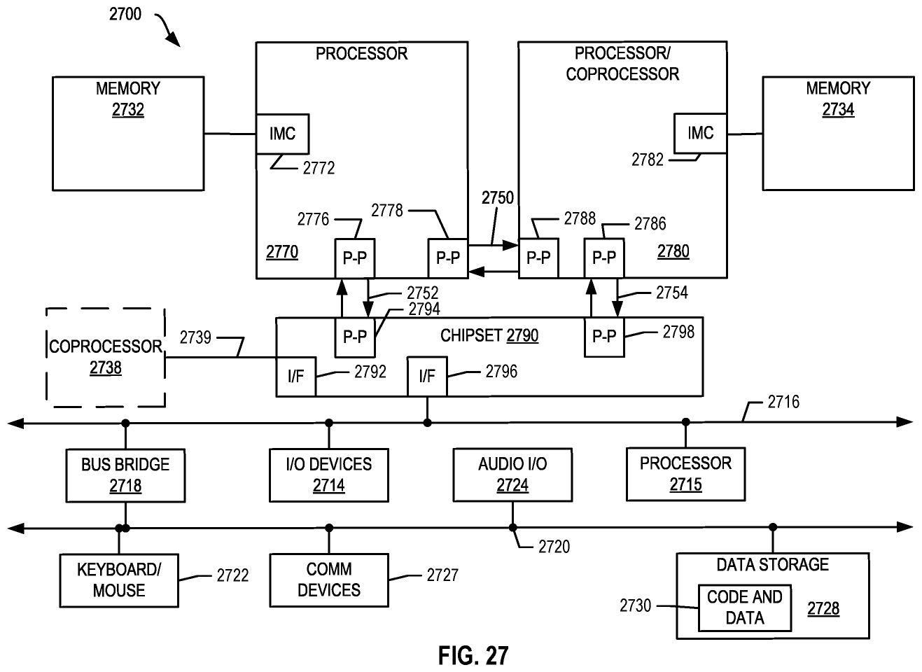

Referring now to FIG. 27, shown is a block diagram of a first more specific exemplary system 2700 in accordance with an embodiment of the present disclosure. As shown in FIG. 27, multiprocessor system 2700 is a point-to-point interconnect system, and includes a first processor 2770 and a second processor 2780 coupled via a point-to-point interconnect 2750. Each of processors 2770 and 2780 may be some version of the processor 2500. In one embodiment of the disclosure, processors 2770 and 2780 are respectively processors 2610 and 2615, while coprocessor 2738 is coprocessor 2645. In another embodiment, processors 2770 and 2780 are respectively processor 2610 coprocessor 2645.

Processors 2770 and 2780 are shown including integrated memory controller (IMC) units 2772 and 2782, respectively. Processor 2770 also includes as part of its bus controller units point-to-point (P-P) interfaces 2776 and 2778; similarly, second processor 2780 includes P-P interfaces 2786 and 2788. Processors 2770, 2780 may exchange information via a point-to-point (P-P) interface 2750 using P-P interface circuits 2778, 2788. As shown in FIG. 27, IMCs 2772 and 2782 couple the processors to respective memories, namely a memory 2732 and a memory 2734, which may be portions of main memory locally attached to the respective processors.

Processors 2770, 2780 may each exchange information with a chipset 2790 via individual P-P interfaces 2752, 2754 using point to point interface circuits 2776, 2794, 2786, 2798. Chipset 2790 may optionally exchange information with the coprocessor 2738 via a high-performance interface 2739. In one embodiment, the coprocessor 2738 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 2790 may be coupled to a first bus 2716 via an interface 2796. In one embodiment, first bus 2716 may be a Peripheral Component Interconnect (PCI) bus, or a bus such as a PCI Express bus or another third generation I/O interconnect bus, although the scope of the present disclosure is not so limited.

As shown in FIG. 27, various I/O devices 2714 may be coupled to first bus 2716, along with a bus bridge 2718 which couples first bus 2716 to a second bus 2720. In one embodiment, one or more additional processor(s) 2715, such as coprocessors, high-throughput MIC processors, GPGPU's, accelerators (such as, e.g., graphics accelerators or digital signal processing (DSP) units), field programmable gate arrays, or any other processor, are coupled to first bus 2716. In one embodiment, second bus 2720 may be a low pin count (LPC) bus. Various devices may be coupled to a second bus 2720 including, for example, a keyboard and/or mouse 2722, communication devices 2727 and a storage unit 2728 such as a disk drive or other mass storage device which may include instructions/code and data 2730, in one embodiment. Further, an audio I/O 2724 may be coupled to the second bus 2720. Note that other architectures are possible. For example, instead of the point-to-point architecture of FIG. 27, a system may implement a multi-drop bus or other such architecture.

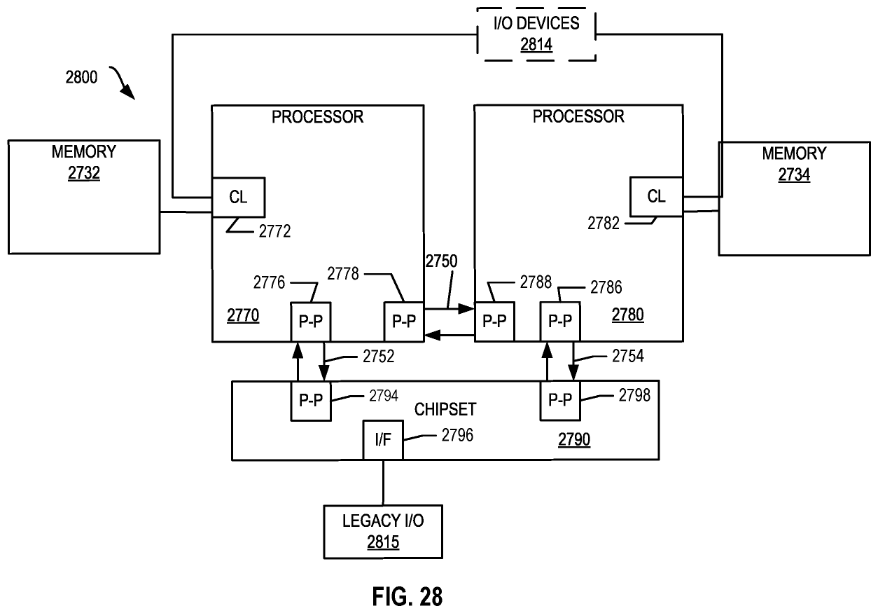

Referring now to FIG. 28, shown is a block diagram of a second more specific exemplary system 2800 in accordance with an embodiment of the present disclosure. Like elements in FIGS. 27 and 28 bear like reference numerals, and certain aspects of FIG. 27 have been omitted from FIG. 28 in order to avoid obscuring other aspects of FIG. 28.

FIG. 28 illustrates that the processors 2770, 2780 may include integrated memory and I/O control logic (“CL”) 2772 and 2782, respectively. Thus, the CL 2772, 2782 include integrated memory controller units and include I/O control logic. FIG. 28 illustrates that not only are the memories 2732, 2734 coupled to the CL 2772, 2782, but also that I/O devices 2814 are also coupled to the control logic 2772, 2782. Legacy I/O devices 2815 are coupled to the chipset 2790.

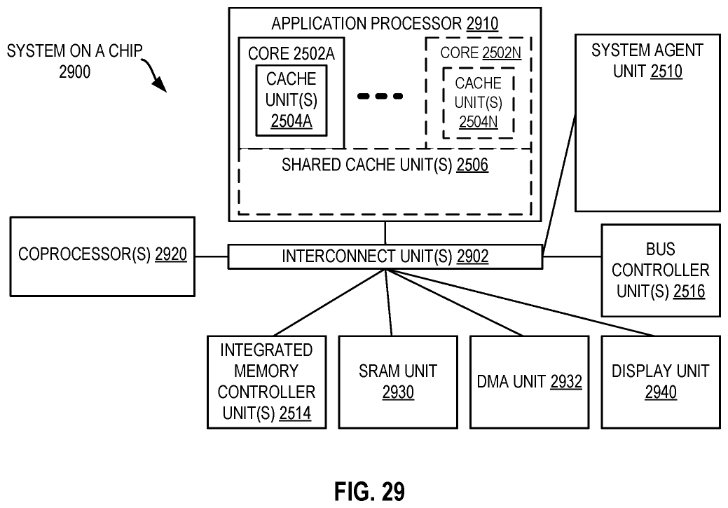

Referring now to FIG. 29, shown is a block diagram of a SoC 2900 in accordance with an embodiment of the present disclosure. Similar elements in FIG. 25 bear like reference numerals. Also, dashed lined boxes are optional features on more advanced SoCs. In FIG. 29, an interconnect unit(s) 2902 is coupled to: an application processor 2910 which includes a set of one or more cores 202A-N and shared cache unit(s) 2506; a system agent unit 2510; a bus controller unit(s) 2516; an integrated memory controller unit(s) 2514; a set or one or more coprocessors 2920 which may include integrated graphics logic, an image processor, an audio processor, and a video processor; a static random access memory (SRAM) unit 2930; a direct memory access (DMA) unit 2932; and a display unit 2940 for coupling to one or more external displays. In one embodiment, the coprocessor(s) 2920 include a special-purpose processor, such as, for example, a network or communication processor, compression engine, GPGPU, a high-throughput MIC processor, embedded processor, or the like.

Embodiments (e.g., of the mechanisms) disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 2730 illustrated in FIG. 27, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

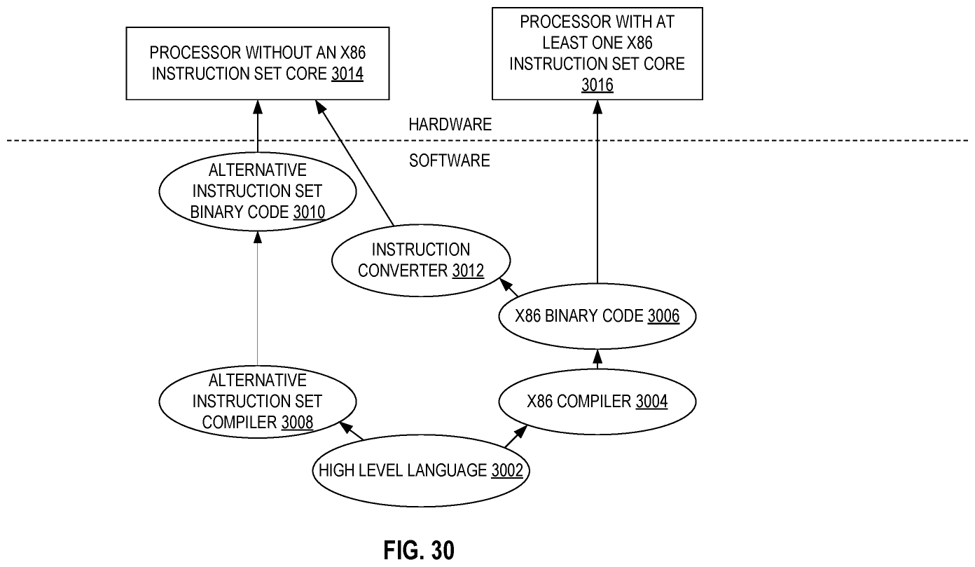

FIG. 30 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 30 shows a program in a high level language 3002 may be compiled using an x86 compiler 3004 to generate x86 binary code 3006 that may be natively executed by a processor with at least one x86 instruction set core 3016. The processor with at least one x86 instruction set core 3016 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 3004 represents a compiler that is operable to generate x86 binary code 3006 (e.g., object code) that can, with or without additional linkage processing, be executed on the processor with at least one x86 instruction set core 3016. Similarly, FIG. 30 shows the program in the high level language 3002 may be compiled using an alternative instruction set compiler 3008 to generate alternative instruction set binary code 3010 that may be natively executed by a processor without at least one x86 instruction set core 3014 (e.g., a processor with cores that execute the MIPS instruction set of MIPS Technologies of Sunnyvale, CA and/or that execute the ARM instruction set of ARM Holdings of Sunnyvale, CA). The instruction converter 3012 is used to convert the x86 binary code 3006 into code that may be natively executed by the processor without an x86 instruction set core 3014. This converted code is not likely to be the same as the alternative instruction set binary code 3010 because an instruction converter capable of this is difficult to make; however, the converted code will accomplish the general operation and be made up of instructions from the alternative instruction set. Thus, the instruction converter 3012 represents software, firmware, hardware, or a combination thereof that, through emulation, simulation or any other process, allows a processor or other electronic device that does not have an x86 instruction set processor or core to execute the x86 binary code 3006.

What is claimed is:

1. An apparatus comprising:
a plurality of memory tiles, one or more of the memory tiles to store data elements of a first matrix and a second matrix;
a plurality of compute tiles arranged in a two-dimensional array, each compute tile to perform matrix multiplication operations;
a plurality of interconnects to couple each compute tile of the plurality of compute tiles to a corresponding subset of memory tiles of the plurality of memory tiles;
an external memory interface to couple the plurality of memory tiles to an external memory; and
a first compute tile of the plurality of compute tiles comprising:
an instruction memory to store an instruction indicating the data elements of the first matrix and the second matrix,
a local memory to store the data elements of the first matrix and the second matrix;
a decoder to decode the instruction, and
multiply-accumulate circuitry to execute the instruction over multiple execution lanes to generate multiple corresponding accumulated values, the multiply-accumulate circuitry comprising:
a plurality of multipliers to multiply the data elements of the first matrix by corresponding data elements of the second matrix to generate a corresponding plurality of products; and
a plurality of adders to add one or more products of the plurality of products to a corresponding accumulated value within each execution lane to generate a corresponding new accumulated value.

2. The apparatus of claim 1, wherein each compute tile of the plurality of compute tiles includes a scalar unit comprising:
a plurality of scalar registers to store scalar data elements, and
a scalar arithmetic logic unit (ALU) to execute scalar instructions using the scalar data elements.

3. The apparatus of claim 1, wherein the data elements of the second matrix comprise neural network weights.

4. The apparatus of claim 3, wherein the data elements of the first matrix indicate input features.

5. The apparatus of claim 4, further comprising:
logic to compute an activation function based on the new accumulated value.

6. The apparatus of claim 5, wherein the new accumulated value comprises a final accumulated value.

7. The apparatus of claim 1, wherein the instruction is to indicate a first size associated with the first matrix and a second size associated with the second matrix.

8. The apparatus of claim 1, wherein the data elements of the first matrix and the second matrix are floating-point values.

9. An apparatus comprising:
a plurality of memories, one or more of the memories to store data elements of a first matrix and a second matrix;
a plurality of matrix processors coupled in a two-dimensional array, each matrix processor to perform matrix multiplication operations;
a plurality of interconnects to couple each matrix processor of the plurality of matrix processors to a corresponding subset of memories of the plurality of memories;
an external memory interface to couple the plurality of memories to an external memory; and
a first matrix processor of the plurality of matrix processors comprising:
an instruction memory to store an instruction indicating the data elements of the first matrix and the second matrix;
a local memory to store the data elements of the first matrix and the second matrix;
a decoder to decode the instruction;
multiply-accumulate circuitry to execute the instruction over multiple execution lanes to generate multiple corresponding accumulated values, the multiply-accumulate circuitry comprising:
a plurality of multipliers to multiply the data elements of the first matrix by corresponding data elements of the second matrix to generate a corresponding plurality of products; and
a plurality of adders to add one or more products of the plurality of products to a corresponding accumulated value within each execution lane to generate a corresponding new accumulated value.

10. The apparatus of claim 9, wherein each matrix processor of the plurality of matrix processors includes a scalar unit comprising:
a plurality of scalar registers to store scalar data elements, and
a scalar arithmetic logic unit (ALU) to execute scalar instructions using the scalar data elements.

11. The apparatus of claim 9, wherein the data elements of the second matrix comprise neural network weights.

12. The apparatus of claim 11, wherein the data elements of the first matrix indicate input features.

13. The apparatus of claim 12, further comprising:
logic to compute an activation function based on the new accumulated value.

14. The apparatus of claim 13, wherein the new accumulated value comprises a final accumulated value.

15. The apparatus of claim 9, wherein the instruction is to indicate a first size associated with the first matrix and a second size associated with the second matrix.

16. The apparatus of claim 9, wherein the data elements of the first matrix and the second matrix are floating-point values.
